(19) United States
(12) Patent Application Publication
(10) Pub. No.: US 2016/0280551 A1
(43) Pub. Date: Sep. 29, 2016

(54) GRAPHENE POWDER, APPARATUS FOR PRODUCING GRAPHENE POWDER, METHOD FOR PRODUCING GRAPHENE POWDER, AND PRODUCT USING GRAPHENE POWDER

(71) Applicant: GRAPHENE PLATFORM CORPORATION, Tokyo (JP)

(72) Inventors: Shoji Hasegawa, Tokyo (JP); Nagisa Kamiya, Tokyo (JP)

(73) Assignee: Graphene Platform Corporation, Tokyo (JP)

(21) Appl. No.: 14/432,733

(22) PCT Filed: Dec. 17, 2013
(86) PCT No.: PCT/JP2013/083795

§ 371 Date: Mar. 31, 2015

(51) Int. Cl. C01B 31/04; B02C 19/06

(52) U.S. Cl. CPC C01B 31/0446; B02C 19/065

(57) ABSTRACT

There are provided graphene powder that may be mass-produced with high quality, an apparatus for producing graphene powder, a method for producing graphene powder, and a product using the graphene powder. A jet flow as a high speed jet stream of a liquid or a gas is output from a jet flow output unit, and a raw material containing graphite and the jet flow thus output from the jet flow output unit are made to inflow to an input part of a chamber to cleave graphite, thereby outputting graphene powder in the form of fine particles of graphite from an output part. The graphene powder by the production method is formed simply by cleaving the raw material containing graphite with a jet flow, and thus may suffer no contamination due to the absence of contamination with other substances, and thus graphene having high purity and good quality in the form of fine particles may be obtained.

### TECHNICAL FIELD

The present invention relates to a method for mass-producing graphene powder from graphite, and particularly relates to graphene powder that is produced thereby, an apparatus for producing graphene powder, a method for producing graphene powder, and a product using the graphene powder.

### BACKGROUND ART

In recent years, studies relating to graphene have been actively made, and the production technique of graphene is being drastically developed in these several years. Examples of the known production method of graphene include a supercritical method, an ultrasonic stripping method, a redox method, a plasma stripping method, an ACCVD (alcohol catalytic chemical vapor deposition) method, a thermal CVD (chemical vapor deposition) method, a plasma CVD method and an epitaxial method. In an supercritical method, graphite is added to a supercritical solution of ethanol, and thereby graphene is stripped therefrom by making the solvent molecules in the supercritical solution intervene between the layers, but the method has a problem that the equipment therefor has a large size due to the processing of the supercritical solution at a high temperature and a high pressure, and it is difficult to process a large amount of the material at once. In the ultrasonic stripping method, graphite is added to a solution, to which an ultrasonic wave is applied, and thereby graphene is stripped therefrom with vibration, but the method has a problem that the stripping process is time-consuming, and it is difficult to process a large amount of the material at once. In the redox method, graphite is oxidized with hydrochloric acid or sulfuric acid, thereby making graphite into thin flakes, but the method has a problem that graphene is necessarily oxidized and then reduced by electrolysis or with a chemical reagent, but it is difficult to reduce the graphene completely, resulting in graphene with low quality. In the plasma stripping method, graphite is placed in a furnace and stripped with plasma discharge, but the method has a problem that many pores are formed on the surface of graphene due to the plasma. In the ACCVD method, ethanol and a metal catalyst are placed in a vacuum furnace, and ethanol is decomposed by heating the furnace to 1,000° C., thereby providing graphene crystals, but the method has a problem that the equipment therefor has a large size, and it is difficult to process a large amount of the material at once. In the thermal CVD method, methane gas is introduced into a vacuum furnace, and the gas is decomposed by heating to 1,000° C. and formed into a film on a metal substrate, but the method has a problem that it is necessary to melt the substrate for taking out graphene although graphene with good crystallinity is obtained. In the plasma CVD method, methane gas is introduced into a vacuum furnace, and the gas is decomposed with plasma and formed into a film on a metal substrate, but the method has a problem that graphene has poor crystallinity although the processing temperature is lower than the thermal CVD method, and it is necessary to melt the substrate for taking out graphene. In the epitaxial method, while a SiC substrate heated to a high temperature of 1,500° C. or more in a vacuum furnace, Si (silicon) is sublimated therein, and thereby only C (carbon) is recrystallized on the substrate, but the temperature is necessarily homogeneous since the purity and the flatness of the wafer vary depending on the temperature, which makes the equipment and the wafer expensive, and the method is not suitable for mass production.

As shown in Patent Literature 1, furthermore, there is a method, in which graphite crystals or a graphite interlayer compound produced from graphite crystals is stirred in water or an organic solvent, and thereby graphite layers are stripped from the graphite crystals or the graphite interlayer compound.

### CITATION LIST

### Patent Literature

Patent Literature 1: JP-A-2011-032156 (paragraphs 0058 to 0060)

### SUMMARY OF INVENTION

### Technical Problem

However, Patent Literature 1 still has a problem that the stirring process is time-consuming, and it is difficult to process a large amount of the material at once.

As described above, it is difficult to process a large amount of the material at a high speed by the ordinary production methods, and thus it is difficult to mass-produce graphene by the methods. Separately, in the application of graphene thus produced to other products, pure graphene having high purity without impurities is demanded.

For example, furthermore, in the case where a product containing graphene is produced by adding graphene to an electronic component, a resin, a petroleum product, pulp, cement and the like, it is considered that graphene is powdered to form graphene powder, which may be easily dispersed in a resin. However, it is difficult to mass-produce graphene powder having good quality by the ordinary methods described above.

The invention has been made in view of the problems, and an object thereof is to provide graphene powder that may be mass-produced with high quality, an apparatus for producing graphene powder, a method for producing graphene powder, and a product using the graphene powder.

### Solution to Problem

For solving the problems, the graphene powder of the invention may have a feature that:

graphene powder is formed through cleavage of a raw material containing graphite into fine particles with a jet flow.

According to the feature, graphite may be formed into fine particles to provide graphene powder through cleavage of graphite by utilizing a jet flow, such as a high speed jet stream of a liquid or a gas. The graphene powder is formed simply by cleaving the raw material containing graphite with a jet flow, and thus may suffer no contamination due to the absence of contamination with other substances, and thus graphene having high purity and good quality in the form of fine particles may be obtained. The graphene powder is formed simply by cleaving graphite by utilizing a jet flow, and thus may be mass produced at a high speed with high quality. The raw material containing graphite used may be not only graphite but also graphite powder.

The cleavage referred herein means breakage of a crystal in parallel to a particular plane and also means the property liable to be broken in such manner. This occurs because of the weak bonding force between atoms, ions or molecules, in the direction perpendicular to the cleavage surface formed through the parallel breakage. Graphene has the bonding force between atoms, ions or molecules that is derived from the van der Waals force and thus has the property liable to cause cleavage. The formation of fine particles referred herein means formation of very fine powder and means that graphite is miniaturized to the optimum particle size. The powder referred herein includes not only a spherical shape but also a flake shape having cleavage surfaces like leaves due to the two-dimensional cleavage. By the formation of fine particles, the graphene powder is constituted by graphite that is formed into flakes having a suitable particle size. By the formation of flakes, a large surface area is obtained to increase the contact area to other substances, thereby enhancing the conductivity and the dispersibility. In particular, the graphene powder may be formed to have a flake shape, and thereby the dispersibility thereof is enhanced to achieve a large dispersed amount.

The graphene powder of the invention may have a feature that:

the graphene powder is cleaved by making the jet flow collide with the graphite in a chamber.

According to the feature, the jet flow is injected toward the graphite in a chamber, which is a closed vessel, thereby forming the graphene powder in the form of fine particles through cleavage of the graphite.

The graphene powder of the invention may have a feature that:

the graphene powder is cleaved by making jet flows inflow to the chamber in at least two directions, in which the graphite is contained in the jet flow in at least one direction, and making the jet flows inflowing in two directions collide with each other.

According to the feature, the jet flows are made to inflow to the chamber, which is a closed vessel, in at least two directions, in which the jet flow in one direction contains the graphite, whereas the jet flow in the other direction contains only the jet flow or contains the graphite, and are made to collide with each other, thereby forming the graphene powder in the form of fine particles through cleavage of the graphite. As the two directions, for example, the jet flows in opposite directions to each other may be made to collide with each other. In this case, the jet flow in one direction that contains the graphite and the jet flow in the other direction that also contains the graphite may be made to collide with each other, and the jet flow in one direction that contains the graphite and the jet flow in the other direction that does not contain the graphite may be made to collide with each other.

The graphene powder of the invention may have a feature that:

the graphene powder is cleaved by making the jet flow that contains graphite inflow to the chamber, and making the jet flow that contains graphite collide with the chamber.

According to the feature, the jet flow that contains graphite is made to inflow to the chamber, which is a closed vessel, and made to collide with the wall of the chamber, thereby forming the graphene powder in the form of fine particles through cleavage of the graphite.

The graphene powder of the invention may have a feature that:

the graphene powder is cleaved by making the jet flow that contains graphite inflow to a chamber having a liquid filled therein, so as to create a cavitation effect.

According to the feature, a chamber, which is a closed vessel, is filled with a liquid, and the jet flow that contains graphite is made to inflow to the chamber, so as to create a cavitation effect, thereby forming the graphene powder in the form of fine particles through cleavage of the graphite. The cavitation effect referred herein means a physical phenomenon, in which bubbles are generated and extinguished in a short period of time due to a pressure difference in a liquid flow, and is also referred to as cavitation. The pressure difference is formed by making the jet flow inflow to the liquid, whereby bubbles thus generated penetrate into the cleavage surfaces to clave the graphite, and the extinguishment of the bubbles cleaves the graphite.

The graphene powder of the invention may have a feature that:

the raw material containing graphite has been subjected to a pretreatment for weakening the bonding force of graphene.

According to the feature, the raw material containing graphite has been subjected to a pretreatment for weakening the bonding force of graphene, thereby facilitating the cleavage of the graphite.

The graphene powder of the invention may have a feature that:

the pretreatment applied to the raw material containing graphite is at least one treatment of a depressurization treatment of decreasing a pressure of an atmosphere of the raw material containing graphite, a heating treatment of heating the raw material, a solvent immersion treatment of immersing the raw material into an acidic or alkaline solvent, and a vibration treatment of applying an ultrasonic vibration to the raw material.

According to the feature, the pretreatment performed may be one treatment, for example, of a depressurization treatment of decreasing a pressure of an atmosphere of the raw material containing graphite by depressurizing a vacuum furnace having the raw material containing graphite placed therein, a heating treatment of heating the raw material in a vacuum furnace having the raw material containing graphite placed therein, a solvent immersion treatment of immersing the raw material into an acidic or alkaline solvent having a low concentration, and a vibration treatment of applying an ultrasonic vibration to the raw material. The plural treatments may be appropriately combined.

The graphene powder of the invention may have a feature that:

the graphene powder is subjected, after the cleavage, to one treatment of an atmospheric pressure plasma treatment, an ultraviolet ray ozone treatment, and a vacuum plasma treatment.

According to the feature, the graphene powder is subjected, after the cleavage, to one modification treatment of an atmospheric pressure plasma treatment, an ultraviolet ray ozone treatment, and a vacuum plasma treatment, thereby enhancing the quality of the graphene powder. Specifically, the modification treatment performed may impart dispersibility, electroconductivity, thermal conductivity, insulating property, heat radiation property, and the like to the graphene powder, thereby enhancing the quality of the graphene powder.

The graphene powder of the invention may have a feature that:

the jet flow is constituted by a liquid, and the graphene powder is obtained by drying the liquid after the cleavage.

According to the feature, a liquid, such as water and a solvent, is pressurized with a pump or the like to form a liquid jet flow as an ultrahigh speed jet stream, and the raw material containing graphite may be cleaved with the liquid jet flow. In this case, the graphene powder may be obtained by drying the liquid after the cleavage. Furthermore, for example, in the case where the liquid is utilized as a solvent, the liquid may not be dried but may be utilized as a solvent containing the graphene powder, and thereby the production of a product utilizing the graphene powder may be advantageously facilitated.

The graphene powder of the invention may have a feature that:

the jet flow is constituted by a gas, a liquid or a solvent.

According to the feature, a liquid, such as water and a solvent, may be pressurized with a pump or the like to form a liquid jet flow as an ultrahigh speed jet stream, and the raw material containing graphite may be cleaved with the liquid jet flow, and a gas, such as air and other gases, may be pressurized with a compressor or the like to form a gas jet flow as an ultrahigh speed jet stream, and the raw material containing graphite may be cleaved with the gas jet flow.

The graphene powder of the invention may have a feature that:

the graphene powder is mixed, after the cleavage, with one of water, a solvent, a resin, and an ionic liquid.

According to the feature, the graphene powder is mixed, after the cleavage, with one of water, a solvent, a resin, and an ionic liquid, and thereby the production of a product utilizing the graphene powder may be advantageously facilitated. In particular, the graphene powder may be in the form of flakes to have enhanced dispersibility, and the dispersed amount of the graphene powder in water, a solvent, a resin, and an ionic liquid may be enhanced.

The graphene powder of the invention may have a feature that:

the jet flow has a velocity of from 100 to 1,000 m/s.

According to the feature, the ultrahigh speed jet has a velocity in a range of from 100 to 1,000 m/s, and thereby the material containing graphite may be cleaved with the jet flow. In this case, the velocity of from 100 to 1,000 m/s may be achieved with a jet flow nozzle diameter of from 0.1 to 1 mm and a jet flow pressure of from 10 to 500 MPa.

The graphene powder of the invention may have a feature that:

the graphene powder is constituted by 70% or more of graphene powder that has a length of a longer edge of the cleavage surface that is from 30 to 10,000 times the thickness of the graphene powder.

According to the feature, the graphene powder that has a thickness, for example, of from 0.3 to 100 nm for a graphene single layer to approximately 300 layers maybe controlled to have a length of a longer edge of the cleavage surface that is from 30 to 10,000 times the thickness thereof, and the graphene powder is constituted by 70% or more of such graphene powder.

The graphene powder of the invention may have a feature that:

the graphene powder is constituted by 70% or more of graphene powder that has a length of a longer edge of the cleavage surface that is from 50 to 3,000 times the thickness of the graphene powder.

According to the feature, the graphene powder that has a thickness, for example, of from 0.3 to 100 nm for a graphene single layer to approximately 300 layers may be controlled to have a length of a longer edge of the cleavage surface that is from 50 to 3,000 times the thickness thereof, and the graphene powder is constituted by 70% or more of such graphene powder.

For solving the problems, the apparatus for producing graphene powder of the invention may have a feature that:

the apparatus comprises a jet flow output unit which outputs a jet flow, and a chamber having a closed space, and

the chamber contains an input part that inputs a raw material containing graphite and a jet flow that is output from the jet flow output unit, and an output part that outputs graphene powder in the form of fine particles formed through cleavage of the graphite with the jet flow.

According to the feature, the jet flow output unit outputs a jet flow, such as a high speed jet stream of a liquid or a gas, and there input part of the chamber inputs the raw material containing graphite and the jet flow thus output from the jet flow output unit so as to cleave graphite, thereby providing graphene powder formed by making graphite into fine particles, and then the resulting graphene powder is output from the output part. The graphene powder by the production method is formed only by cleaving the raw material containing graphite with the jet flow, and thus may suffer no contamination due to the absence of contamination with other substances, and thus graphene having high purity and good quality in the form of fine particles may be obtained. The graphene powder is formed simply by cleaving graphite by utilizing a jet flow, and thus may be mass produced at a high speed with high quality. By forming the graphene powder in the form of flakes, a large surface area is obtained to increase the contact area to other substances, thereby enhancing the conductivity and the dispersibility. In particular, the graphene powder is formed to have a flake shape, and thereby the dispersibility thereof is enhanced to achieve a large dispersed amount.

The apparatus for producing graphene powder of the invention may have a feature that:

the input part of the chamber has a first input unit that inputs the raw material, a second input unit that inputs the jet flow output from the jet flow output unit, and a control unit that controls inputting directions of the first input unit and the second input unit to the chamber.

According to the feature, the first input unit inputs the raw material, the second input unit inputs the jet flow output from the jet flow output unit, and the control unit controls the inputting directions of the first input unit and the second input unit to the chamber, whereby the graphite input by the first input unit and the jet flow input by the second input unit may be made to collide with each other in the chamber, which is a closed vessel, thereby producing the graphene powder in the form of fine particles through cleavage of the graphite. The control unit may control the directions of the first input unit and the second input unit, for example, to opposite directions to each other, thereby making the graphite and the jet flow collide with each other.

The apparatus for producing graphene powder of the invention may have a feature that:

the jet flow output unit receives the raw material containing graphite and outputs the jet flow that contains graphite, and

the input part of the chamber has a first input unit and a second input unit that input the jet flow that contains graphite thus output from the jet flow output unit, and a control unit that controls inputting directions of the first input unit and the second input unit to the chamber.

According to the feature, the first input unit inputs the jet flow that contains graphite, the second input unit also inputs the jet flow that contains graphite, and the control unit controls the inputting directions of the first input unit and the second input unit to the chamber, whereby the jet flow that contains graphite input by the first input unit and the jet flow that contains graphite input by the second input unit may be made to collide with each other in the chamber, which is a closed vessel, thereby producing the graphene powder in the form of fine particles through cleavage of the graphite by making graphite from the two directions collide with each other. The control unit may control the directions of the first input unit and the second input unit, for example, to opposite directions to each other, thereby making the jet flows containing graphite collide with each other.

The apparatus for producing graphene powder of the invention may have a feature that:

the jet flow output unit receives the raw material containing graphite and outputs the jet flow that contains graphite, and

the input part of the chamber has a first input unit that inputs the jet flow that contains graphite thus output from the jet flow output unit, and a control unit that controls inputting direction of the first input unit to the chamber.

According to the feature, the first input unit inputs the jet flow that contains graphite, and the control unit controls the inputting direction of the first input unit to the chamber, whereby the graphite may be made to collide with a particular position of the wall of the chamber, thereby producing the graphene powder in the form of fine particles through cleavage of the graphite.

The apparatus for producing graphene powder of the invention may have a feature that:

the chamber has a liquid filled therein, and the graphite and the jet flow input by the input part create a cavitation effect.

According to the feature, the chamber, which is a closed vessel, is filled with a liquid, and the jet flow that contains graphite may be made to inflow to the chamber, so as to create a cavitation effect, thereby producing the graphene powder in the form of fine particles through cleavage of the graphite.

The apparatus for producing graphene powder of the invention may have a feature that:

the apparatus comprises a pretreatment part that subjects the raw material containing graphite to a pretreatment for weakening the bonding force of graphene.

According to the feature, the raw material containing graphite may be subjected to a pretreatment for weakening the bonding force of graphene, thereby facilitating the cleavage of the graphite.

The apparatus for producing graphene powder of the invention may have a feature that: the pretreatment performed is at least one treatment of a depressurization treatment of decreasing a pressure of an atmosphere of the raw material containing graphite, a heating treatment of heating the raw material, a solvent immersion treatment of immersing the raw material into an acidic or alkaline solvent, and a vibration treatment of applying an ultrasonic vibration to the raw material.

According to the feature, the pretreatment performed may be one treatment, for example, of a depressurization treatment of decreasing a pressure of an atmosphere of the raw material containing graphite by depressurizing a vacuum furnace having the raw material, containing graphite placed therein, a heating treatment of heating the raw material in a vacuum furnace having the raw material containing graphite placed therein, a solvent immersion treatment of immersing the raw material into an acidic or alkaline solvent having a low concentration, and a vibration treatment of applying an ultrasonic vibration to the raw material. The plural treatments may be appropriately combined.

The apparatus for producing graphene powder of the invention may have a feature that:

the apparatus comprises a treatment part that subjects the graphene powder output from the chamber, to one of an atmospheric pressure plasma treatment, an ultraviolet ray ozone treatment, and a vacuum plasma treatment.

According to the feature, the treating part may subject the graphene powder after the cleavage to one modification treatment of an atmospheric pressure plasma treatment, an ultraviolet ray ozone treatment, and a vacuum plasma treatment, thereby enhancing the quality of the graphene powder. Specifically, the modification treatment performed may impart dispersibility, electroconductivity, thermal conductivity, insulating property, heat radiation property, and the like to the graphene powder, thereby enhancing the quality of the graphene powder.

The apparatus for producing graphene powder of the invention may have a feature that:

the jet flow output unit outputs a jet flow of a liquid,

the input part of the chamber inputs the jet flow of a liquid,

the output part of the chamber outputs graphene powder containing the liquid, and

the apparatus for producing graphene powder comprises a drying part that dries the liquid of the graphene powder containing the liquid output from the chamber.

According to the feature, the jet flow output unit outputs a liquid jet flow as an ultrahigh speed jet stream by pressurizing a liquid, such as water and a solvent, with a pump or the like, and the input part of the chamber inputs the liquid jet flow, thereby cleaving the raw material containing graphite with the liquid jet flow. In this case, the liquid may be dried in the drying part after the cleavage to produce the graphene powder containing no liquid. Furthermore, for example, in the case where the liquid is used as a solvent, the liquid may not be dried but may be used as a solvent containing the graphene powder, and thereby the production of a product utilizing the graphene powder may be advantageously facilitated.

The apparatus for producing graphene powder of the invention may have a feature that:

the jet flow output unit outputs a jet flow of a gas, a liquid or a solvent.

According to the feature, the jet flow output unit may output a liquid jet flow as an ultrahigh speed jet stream by pressurizing a liquid, such as water and a solvent, with a pump or the like, thereby cleaving the raw material containing graphite with the liquid jet flow, and the jet flow output unit may output a gas jet flow as an ultrahigh speed jet stream by pressurizing a gas, such as air and other gases, with a compressor or the like, thereby cleaving the raw material containing graphite with the gas jet flow.

The apparatus for producing graphene powder of the invention may have a feature that:

the apparatus comprises a mixing unit that mixes the graphene powder output from the chamber with one of water, a solvent, a resin, and an ionic liquid.

According to the feature, the mixing part mixes the graphene powder after cleavage with one of water, a solvent, a resin, and an ionic liquid, and thereby the production of a product utilizing the graphene powder maybe advantageously facilitated. In particular, the graphene powder is in the form of flakes to have enhanced dispersibility, and the dispersed amount of the graphene powder in water, a solvent, a resin, and an ionic liquid may be enhanced..

The apparatus for producing graphene powder of the invention may have a feature that:

the jet flow output unit outputs the jet flow at a velocity of from 100 to 1,000 m/s.

According to the feature, the jet flow output unit outputs the ultrahigh speed jet having a velocity in a range of from 100 to 1,000 m/s, and thereby the material containing graphite may be cleaved with the jet flow. In this case, the velocity of from 100 to 1,000 m/s may be achieved with a jet flow nozzle diameter of from φ0.1 to 1 mm and a jet flow pressure of from 10 to 500 MPa.

The apparatus for producing graphene powder of the invention may have a feature that:

the apparatus comprises a loop part that makes the graphene powder output from the output part of the chamber be input again by the input part of the chamber.

According to the feature, the loop part makes the graphene powder output from the output part of the chamber be input again by the input part of the chamber, thereby producing finer graphene powder.

The apparatus for producing graphene powder of the invention may have a feature that:

the jet flow output unit contains one of

a compression unit that compresses air or a gas, and

a pressurizing unit that pressurizes water or a liquid with a pump.

According to the feature, in the case where air or a gas is used as the jet flow, the jet flow output unit may output an ultrahigh speed jet stream of air or a gas by compressing air or a gas with the compression unit, such as a compressor. In the case where water or a liquid is used as the jet flow, the jet flow output unit may output an ultrahigh speed jet stream of water or a liquid by pressurizing water or a liquid with the pressurizing unit, such as a pump.

The apparatus for producing graphene powder of the invention may have a feature that:

the apparatus for producing graphene powder has a capability of processing the raw material at a rate of at least 1 kg/h or higher in the production of the graphene powder from the raw material.

According to the feature, the graphene powder in the form of fine particles formed from graphite may be obtained simply by cleaving graphite with the jet flow, and thus the processing capability may be enhanced, thereby processing the raw material at a rate of at least 1 kg/h.

The method for producing graphene powder of the invention may have a feature that:

the method comprises the cleaving step of cleaving a raw material containing graphite with a jet flow, thereby producing graphene powder of fine particles.

According to the feature, graphite may be formed into fine particles to provide graphene powder through cleavage of graphite by utilizing a jet flow, such as a high speed jet stream of a liquid or a gas. The graphene powder is formed simply by cleaving the raw material containing graphite with a jet flow, and thus may suffer no contamination due to the absence of contamination with other substances, and thus graphene having high purity and good quality in the form of fine particles may be obtained. The graphene powder is formed simply by cleaving graphite by utilizing a jet flow, and thus may be mass produced at a high speed with high quality. By forming the graphene powder to have a flake shape, furthermore, a large surface area is obtained to increase the contact area to other substances, thereby enhancing the conductivity and the dispersibility. In particular, the graphene powder may be formed to have a flake shape, and thereby the dispersibility thereof is enhanced to achieve a large dispersed amount.

The method for producing graphene powder of the invention may have a feature that:

the jet flow is made to collide with the graphite in a chamber.

According to the feature, the jet flow is injected toward the graphite in a chamber, which is a closed vessel, thereby producing the graphene powder in the form of fine particles through cleavage of the graphite.

The method for producing graphene powder of the invention may have a feature that:

jet flows are made to inflow to the chamber in at least two directions, in which the graphite is contained in the jet flow in at least one direction, and the jet flows inflowing in two directions are made to collide with each other.

According to the feature, the jet flows that contain graphite are made to inflow to the chamber, which is a closed vessel, in at least two directions, thereby making the graphite collide with each other, and thus the graphene powder in the form of fine particles may be produced through cleavage of the graphite. As the two directions, for example, the jet flows in opposite directions to each other may be made to collide with each other, thereby making the graphite collide with each other.

The method for producing graphene powder of the invention may have a feature that:

the jet flow that contains graphite is made to inflow to the chamber, and the jet flow that contains graphite is made to collide with the chamber.

According to the feature, the jet flow that contains graphite is made to inflow to the chamber, which is a closed vessel, and made to collide with the wall of the chamber, thereby forming the graphene powder in the form of fine particles through cleavage of the graphite.

The method for producing graphene powder of the invention may have a feature that:

the jet flow that contains graphite is made to inflow to the chamber having a liquid filled therein, so as to create a cavitation effect.

According to the feature, a chamber, which is a closed vessel, is filled with a liquid, and the jet flow that contains graphite is made to inflow to the chamber, so as to create a cavitation effect, thereby forming the graphene powder in the form of fine particles through cleavage of the graphite.

The method for producing graphene powder of the invention may have a feature that:

the method comprises a pretreatment step of being subjected a pretreatment to the raw material containing graphite for weakening the bonding force of graphene.

According to the feature, the raw material containing graphite has been subjected to a pretreatment for weakening the bonding force of graphene, thereby facilitating the cleavage of the graphite.

The method for producing graphene powder of the invention may have a feature that:

the pretreatment step is at least one treatment of:

a depressurization treatment of decreasing a pressure of an atmosphere of the raw material containing graphite,

a heating treatment of heating the raw material,

a solvent immersion treatment of immersing the raw material into an acidic or alkaline solvent, and

a vibration treatment of applying an ultrasonic vibration to the raw material.

According to the feature, the pretreatment performed may be one treatment, for example, of a depressurization treatment of decreasing a pressure of an atmosphere of the raw material containing graphite by depressurizing a vacuum furnace having the raw material containing graphite placed therein, a heating treatment of heating the raw material in a vacuum furnace having the raw material containing graphite placed therein, a solvent immersion treatment of immersing the raw material into an acidic or alkaline solvent having a low concentration, and a vibration treatment of applying an ultrasonic vibration to the raw material. The plural treatments may be appropriately combined.

The method for producing graphene powder of the invention may have a feature that:

the graphene powder is subjected, after the cleavage, to one treatment of:

an atmospheric pressure plasma treatment,

an ultraviolet ray ozone treatment, and

a vacuum plasma treatment.

According to the feature, the graphene powder is subjected, after the cleavage, to one modification treatment of an atmospheric pressure plasma treatment, an ultraviolet ray ozone treatment, and a vacuum plasma treatment, thereby enhancing the quality of the graphene powder. Specifically, the modification treatment performed may impart dispersibility, electroconductivity, thermal conductivity, insulating property, heat radiation property, and the like to the graphene powder, thereby enhancing the quality of the graphene powder.

The method for producing graphene powder of the invention may have a feature that:

wherein at the cleaving step, a liquid is used as the jet flow, and wherein the method comprises a further step of:

being subjected dry treatment to the graphene powder after the cleaving step.

According to the feature, a liquid, such as water and a solvent, is pressurized with a pump or the like to form a liquid jet flow as an ultrahigh speed jet stream, and the raw material containing graphite may be cleaved with the liquid jet flow. In this case, the graphene powder may be obtained by drying the liquid after the cleavage. Furthermore, for example, in the case where the liquid is utilized as a solvent, the liquid may not be dried but may be utilized as a solvent containing the graphene powder, and thereby the production of a product utilizing the graphene powder may be advantageously facilitated.

The method for producing graphene powder of the invention may have a feature that:

a gas, a liquid or a solvent is used as the jet flow.

According to the feature, a liquid, such as water and a solvent, may be pressurized with a pump or the like to form a liquid jet flow as an ultrahigh speed jet stream, and the raw material containing graphite may be cleaved with the liquid jet flow, and a gas, such as air and other gases, may be pressurized with a compressor or the like to form a gas jet flow as an ultrahigh speed jet stream, and the raw material containing graphite may be cleaved with the gas jet flow.

The method for producing graphene powder of the invention may have a feature that:

the method comprises a further step of:

mixing the graphene powder with one of water, a solvent, a resin, and an ionic liquid, after the cleaving step.

According to the feature, the graphene powder is mixed, after the cleavage, with one of water, a solvent, a resin, and an ionic liquid, and thereby the production of a product utilizing the graphene powder may be advantageously facilitated. In particular, the graphene powder may be in the form of flakes to have enhanced dispersibility, and the dispersed amount of the graphene powder in water, a solvent, a resin, and an ionic liquid may be enhanced.

The method for producing graphene powder of the invention may have a feature that:

the jet flow has a velocity of from 100 to 1,000 m/s.

According to the feature, the ultrahigh speed jet has a velocity in a range of from 100 to 1,000 m/s, and thereby the material containing graphite may be cleaved with the jet flow. In this case, the velocity of from 100 to 1,000 m/s may be achieved with a jet flow nozzle diameter of from φ0.1 to 1 mm and a jet flow pressure of from 10 to 500 MPa.

The method for producing graphene powder of the invention may have a feature that:

the method has a loop step of making the graphene powder output from the chamber be input again by the chamber.

According to the feature, the loop step makes the graphene powder output from the output part of the chamber be input again by the input part of the chamber, thereby producing finer graphene powder.

The method for producing graphene powder of the invention may have a feature that:

the method has, on outputting the jet flow, one of

a compression step of compressing air or a gas with a compressor, and

a pressurizing step of pressurizing water or a liquid with a pump.

According to the feature, in the case where air or a gas is used as the jet flow, an ultrahigh speed jet stream of air or a gas may be output by compressing air or a gas with a compressor or the like. In the case where water or a liquid is used as the jet flow, an ultrahigh speed jet stream of water or a liquid may be output by pressurizing water or a liquid with a pump or the like.

The product using graphene powder of the invention may have a feature that:

the graphene powder is used in one product of an electronic part, device or circuit, an electronic appliance, a household electric component, an automobile component, a machine component, an electric component, a pottery or soil and stone product, a pulp, paper, processed paper or wood product, a chemical industrial product, a petroleum or coal product, a plastic product, and a rubber product.

According to the feature, graphene that has high purity and high quality, is formed into fine particles, and achieves a large dispersed amount may be utilized in various products and components, such as industrial products and electronic appliances. The graphene powder may be mixed in any kind of products due to the excellent electroconductivity, thermal conductivity, transparency and electrode corrosion resistance thereof and the flexibility thereof, and the graphene powder may be dispersed uniformly therein due to the good dispersibility thereof.

The product using graphene powder of the invention may have a feature that:

the graphene powder is used in

one product of a liquid crystal or flat panel, a transparent or opaque electrode, a touch-sensitive panel, a resistor, capacitor, transformer or composite component, an electrode material for an electric double layer capacitor, a rechargeable battery, an electrode material for a primary or secondary cell, an electrode material for a lithium ion cell, an electric generator, electric motor or electric rotary machine, a substrate for a catalyst of a fuel cell, an electric machinery component, a dye-sensitized solar cell, a flexible substrate, and an electronic tag, sensor or sensor unit.

According to the feature, graphene that has high purity and high quality, is formed into fine particles, and achieves a large dispersed amount may be utilized in various products and components, such as industrial products and electronic appliances. The graphene powder may be mixed in any kind of products due to the excellent electroconductivity, thermal conductivity, transparency and electrode corrosion resistance thereof and the flexibility thereof, and the graphene powder may be dispersed uniformly therein due to the good dispersibility thereof. For example, the graphene powder may be dispersed in a solvent, and thereby may be used in one product of a liquid crystal or flat panel, a transparent or opaque electrode, a touch-sensitive panel, a resistor, capacitor, transformer or composite component, an electrode material for an electric double layer capacitor, a rechargeable battery, an electrode material for a primary or secondary cell, an electrode material for a lithium ion cell, an electric generator, electric motor or electric, rotary machine, a substrate for a catalyst of a fuel cell, an electric machinery component, a dye-sensitized solar cell, a flexible substrate, and an electronic tag, sensor or sensor unit, and the use of the graphene powder may provide a product that is excellent in electroconductivity, thermal conductivity, transparency and electrode corrosion resistance.

The product using graphene powder of the invention may have a feature that:

the graphene powder is used in

one product of cement, fresh concrete, a concrete product, an electric ceramic product, a laboratory or industrial ceramic product, a carbonaceous electrode, a carbon or graphite product, an artificial bone, a gypsum product, a gypsum board, plastics, synthetic rubber, a paint, a printing ink, a printed electronic component, gelatin or an adhesive, an oil, a lubricant oil or grease, a pipe, a building material, a food wrap film, a medical wrap film, a kitchen product, a toy, a chassis for an information processing device, a household electric equipment, a beverage PET bottle, a machinery component, an industrial adhesive, a heat radiation grease, a packaging material, engineering plastics, furniture, a tire, medical rubber, a heat resistant gasket, antivibration rubber, and a rubber product.

According to the feature, graphene that has high purity and high quality, is formed into fine particles, and achieves a large dispersed amount may be utilized in various products and components, such as chemical products, pottery or soil and stone products, and commodity products. The addition of the graphene powder to a resin may enhance the strength thereof, and may provide a resin excellent in electroconductivity, thermal conductivity, transparency, corrosion resistance and gas barrier property. Furthermore, the graphene powder may be dispersed uniformly in a resin due to the good dispersibility thereof. For example, the graphene powder may be added to a resin, and thereby may be used in one product of cement, fresh concrete, a concrete product, an electric ceramic product, a laboratory or industrial ceramic product, a carbonaceous electrode, a carbon or graphite product, an artificial bone, a gypsum product, a gypsum board, plastics, synthetic rubber, a paint, a printing ink, a printed electronic component, gelatin or an adhesive, an oil, a lubricant oil or grease, a pipe, a building material, a food wrap film, a medical wrap film, a kitchen product, a toy, a chassis for an information processing device, a household electric equipment, a beverage PET bottle, a machinery component, an industrial adhesive, a heat radiation grease, a packaging material, engineering plastics, furniture, a tire, medical rubber, a heat resistant gasket, antivibration rubber, and a rubber product, and the use of the graphene powder may provide a product that is enhanced in strength and is excellent in electroconductivity, thermal conductivity, corrosion resistance and gas barrier property.

The product using graphene powder of the invention may have a feature that:

the graphene powder is added to a resin,

which is constituted by one of polyvinyl chloride, polyvinylidene chloride, polystyrene, ABS, polyacetal, polycarbonate, PET, a fluorine resin, an epoxy resin, and a silicone resin.

According to the feature, graphene that has high purity and high quality, is formed into fine particles, and achieves a large dispersed amount may be utilized in various resin products and resin components. The addition of the graphene powder to a resin may enhance the strength thereof, and may provide a resin excellent in electroconductivity, thermal conductivity, transparency, corrosion resistance and gas barrier property. Furthermore, the graphene powder may be dispersed uniformly in a resin due to the good dispersibility thereof. For example, the graphene powder may be added to a resin, which maybe constituted by one of polyvinyl chloride, polyvinylidene chloride, polystyrene, ABS, polyacetal, polycarbonate, PET, a fluorine resin, Teflon (a registered trade name), an epoxy resin, and a silicone resin, and the use of the resin having the graphene powder added thereto may provide a resin product excellent in electroconductivity, thermal conductivity, transparency, corrosion resistance and gas barrier property.

The product using graphene powder of the invention may have a feature that:

the graphene powder is dispersed in a liquid at the PZC (point of zero charge).

According to the feature, the graphene powder may be dispersed in a liquid by balancing the potentials of the substances dispersed in the liquid. For example, the graphene powder may be dispersed in a liquid by balancing the potential through control of the pH in the liquid.

The product using graphene powder of the invention may have a feature that:

the liquid is an ink, a solution, or a resin dispersion.

According to the feature, for example, the graphene powder may be dispersed in an ink at the PZC, thereby providing an ink containing the graphene powder (i.e. , a graphene ink). Furthermore, the graphene powder may be dispersed in a solution or a resin dispersion at the PZC, thereby providing a solution containing the graphene powder (i.e. , a graphene solution) or a resin dispersion containing the graphene powder (i.e., a graphene resin dispersion), as a product using the graphene powder.

### BRIEF DESCRIPTION OF DRAWINGS

FIG. 1 is a first block diagram showing an apparatus for producing graphene powder in the examples.

FIG. 2 is illustrative diagrams (a) and (b) for describing cleavage of graphene powder in the examples.

FIG. 3 is a second block diagram showing an apparatus for producing graphene powder in the examples.

FIG. 4 is a third block diagram showing an apparatus for producing graphene powder in the examples.

FIG. 5 is illustrative diagrams (a) and (b) for describing cleavage of graphene powder in the examples.

FIG. 6 is a fourth block diagram showing an apparatus for producing graphene powder in the examples.

FIG. 7 is illustrative diagrams (a) and (b) for describing cleavage of graphene powder in the examples.

FIG. 8 is a fifth block diagram showing an apparatus for producing graphene powder in the examples.

FIG. 9 is illustrative diagrams (a) and (b) for describing cleavage of graphene powder in the examples.

FIG. 10 is a first block diagram showing a production apparatus of mixing graphene powder with a resin, rubber or the like to form pellets of a master batch, and an apparatus for producing a resin or rubber product by using the pellets, in the examples.

FIG. 11 is a second block diagram showing an apparatus for producing a resin or rubber product having graphene powder added thereto in the examples.

FIG. 12 is an image obtained by observing graphene powder with a scanning electron microscope (SEM) in the examples.

FIG. 13 is an illustrative diagram showing a process for producing a product with a master batch having graphene powder added thereto in the examples.

FIG. 14 is (a) a schematic diagram of fine particles through pulverization, and (b) a schematic diagram of graphene powder in the examples.

FIG. 15 is (a) a schematic diagram of fine particles through pulverization and an illustrative diagram showing a state of pulverization thereof, and (b) a schematic diagram of graphene powder in the examples and an illustrative diagram showing a state of cleavage thereof.

FIG. 16 is an illustrative diagram No. 1 showing various products having graphene powder applied thereto and effects thereof in the examples.

FIG. 17 is an illustrative diagram No. 2 showing various products having graphene powder applied thereto and effects thereof in the examples.

### DESCRIPTION OF EMBODIMENTS

Embodiments for producing the graphene powder of the invention and embodiments for producing various products by using the graphene powder thus produced will be described with reference to examples below.

### EXAMPLES

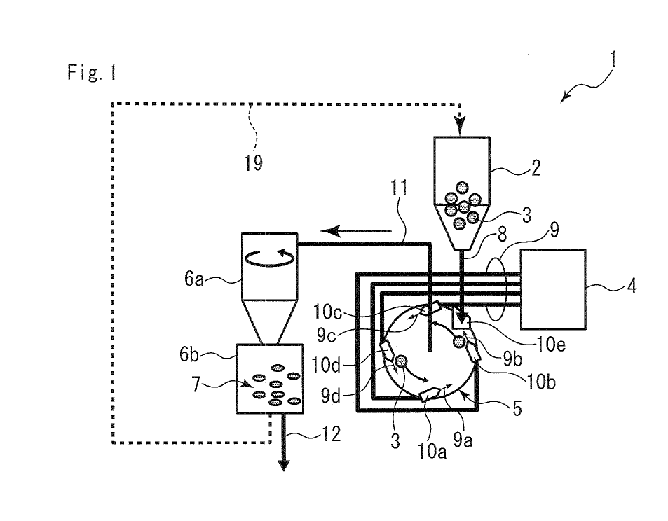

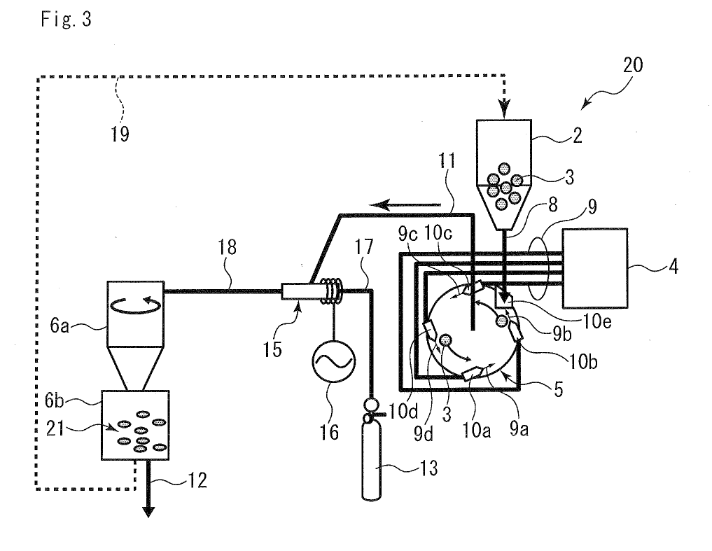

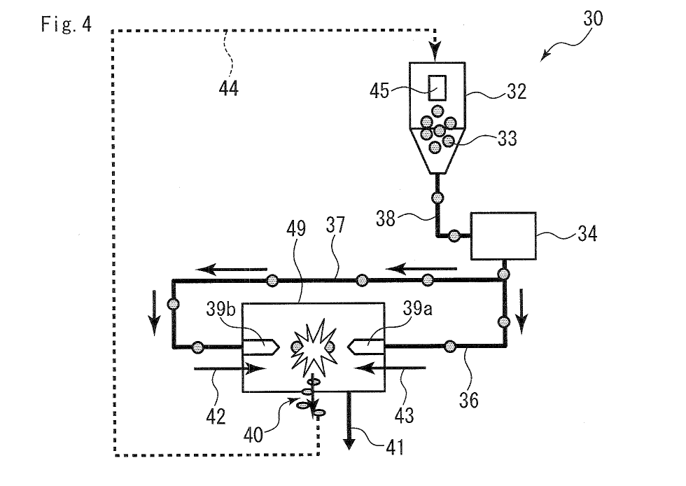

Examples showing embodiments for producing graphene powder of the invention will be described with reference to FIGS. 1 to 9. Five embodiments are shown for the production apparatus of graphene powder in the examples in FIGS. 1, 3, 4, 6 and 8 . The production apparatuses of graphene powder shown in FIGS. 1 and 3 show the cases where a gas is used as a jet flow, and the production apparatuses of graphene powder shown in FIGS. 4, 6 and 8 show the cases where a liquid is used as a jet flow.

FIG. 1 is a first block diagram showing an apparatus for producing graphene powder in the examples.

In FIG. 1, the production apparatus 1 of graphene powder has at least a compressor 4 as a jet flow output unit that outputs a jet flow, and a process chamber 5 as a chamber having a closed space, and the process chamber 5 has an input part 10 that inputs a raw material 3 containing graphite or the like and a jet flow output from the compressor 4, and an output part 11 that outputs graphene powder in the form of fine particles formed through cleavage of graphite with a jet flow in the process chamber 5. The output part 11 is shown schematically in the figure, and may have an output nozzle of the process chamber, and a subsequent pipe.

The compressor 4 as the jet flow output unit is a device that compresses a gas to increase the pressure thereof and continuously delivers the gas, and a normal compressor ordinarily used may be utilized therefor. The compressor 4 compresses a gas, such as air and other gases, and outputs a gas jet flow as an ultrahigh speed jet stream to pipes 9. The gases used maybe nitrogen gas, hydrocarbon gas, hydrogen gas or the like. The discharge pressure of the jet flow from the compressor 4 may be set at approximately from 10 to 500 MPa, and the jet flow nozzle diameter may be set at approximately from 0.1 to 1 mm. According to the configuration, the jet flow may be output at a velocity in a range of approximately from 100 to 1,000 m/s.

The process chamber 5 is a device that is shielded from the air with a valve, which is not shown in the figure, and maintains the inner atmosphere to high vacuum, and a normal drum process chamber having been ordinarily used may be utilized therefor. The raw material 3 containing graphite input from the input part 10 and the gas jet flow output from the compressor 4 are input to the process chamber 5, and in the process chamber 5, a process of cleaving graphite (which is hereinafter referred to as a cleavage process) is performed. After completing the cleavage process, graphene powder 7 thus formed into fine particles through cleavage is output from the output part 11. In the process chamber 5, graphite may be cleaved by injecting the gas jet flows 9a to 9d directly to the raw material for colliding therewith, graphite in the raw material 3 may be cleaved by making graphite collide with the inner wall of the process chamber 5 along with the gas jet flows, or graphite in the raw material 3 may be cleaved by making graphite collide with each other along with the gas jet flows. The input part 10 of the process chamber 5 shown in FIG. 1 inputs the gas jet flow as an ultrahigh speed jet stream and the raw material 3 containing graphite through the pipes 9, and has a first input unit 10a, a second input unit 10b, a third input unit 10c and a fourth input unit 10d for inputting the gas jet flows, and a fifth input unit 10e for inputting the raw material 3. The first to fifth input units 10a to 10e each are constituted by a nozzle. While this example shows the case having five input parts 10 for example, one or plural input parts may be provided as an input part, and six or more input parts may be provided. In this example, the gas and the raw material are input with different input units respectively, but may be input with the same input unit. The input part 10 has a control unit, which is not shown in the figure, for controlling the input directions of the first to fifth input units 10a to 10e into the process chamber 5. The control unit controls the input directions of the gas jet flows 9a to 9e input from the first to fourth input units 10a to 10d into the process chamber 5 and the input direction of the raw material 3 input from the fifth input unit 10e into the process chamber 5. The control unit may be configured to make the input directions of two input units be opposite to each other, or may be configured to make the input directions directed to a particular position of the wall of the process chamber 5. The control unit is not an essential component, and the input directions may be fixed with the input part 10.

The production apparatus 1 of graphene powder may have a raw material tank 2 that receives the raw material 3 and retains the raw material 3 thus received, a dust collector 6a that separates and collects graphene powder output from the process chamber 5, and an output tank 6b that retains and outputs graphene powder.

The raw material 3 used may be one containing graphite, and for example, natural graphite, graphite powder or the like maybe used. The raw material 3 is placed in the raw material tank 2 and input from the fifth input unit 10e through the pipe 8 into the process chamber 5.

The dust collector 6a is a device that separates and collects graphene powder 7 output from the process chamber 5. Examples of the dust collector 6a used include a gravity type utilizing spontaneous precipitation of particles (i.e., a gravity settling chamber), a centrifugal type utilizing centrifugal force (i.e., a cyclone), a filtration type utilizing various filtering media, a collision type where particles are made to collide with and attached to a surface of an obstacle, an electric type (i.e., an electric dust collector), and a sonic type (i.e., a sonic dust collector). In this example, a dry type that collects particles in a dry state is used since air or another gas is used as the gas.

The output tank 6b retains and outputs the graphene powder 7 formed into fine particles through cleavage of graphite. The graphene powder 7 thus output from the output tank 6b maybe again placed in the raw material tank 2 through a pipe 19 depending on the cleavage condition, for repeating the cleavage process.

An example of the production method of graphene powder in this example will be described with reference to FIG. 1. The process chamber 5 is turned on, and the interior of the process chamber 5 is evacuated to vacuum. By evacuating to vacuum, impurities in the process chamber 5 are removed. Subsequently, graphite powder as the raw material 3 is placed in the raw material tank 2, and the raw material 3 is input from the fifth input unit 10e through the pipe 8 into the process chamber 5. The compressor 4 is turned on for compressing a gas, such as air or another gas, from which gas jet flows as an ultrahigh speed jet stream are output at a velocity of 500 m/s to the pipes 9, and the gas jet flows 9a to 9d are input from the first to fourth input units 10a to 10d of the process chamber 5. In the process chamber 5, the gas jet flows input from the first to fourth input units 10a to 10d are made to collide with the raw material 3 containing graphite input from the fifth input unit 10e, thereby performing a cleavage process for cleaving graphite. In the process chamber 5, the input directions toward the process chamber 5 in the first to fifth input units 10a to 10e are controlled to make the gas jet flows be injected to and collide with the raw material 3. In alternative, the input directions are controlled to make graphite in the raw material 3 collide with the inner wall of the process chamber 5 along with the gas jet flows. In the case where the process chamber 5 has a spherical shape, the gas jet flows are rotated along the inner wall of the process chamber 5 to cause streams, which facilitate, collision of the raw material 3 and the gas jet flows.

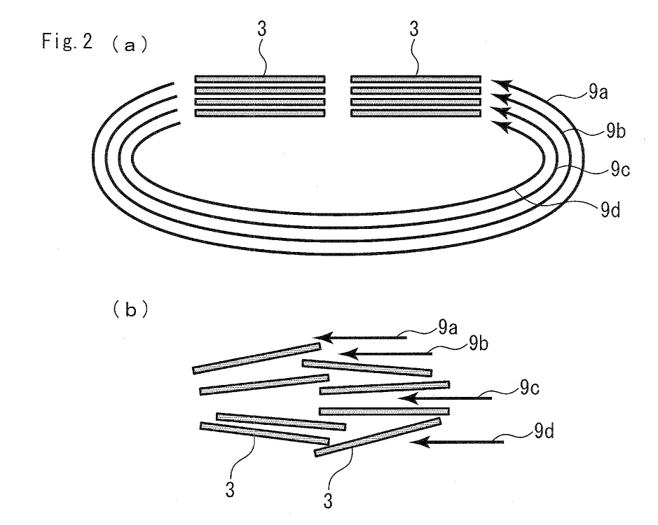

The cleavage process will be described with reference to FIGS. 2(a) and 2(b). FIGS. 2(a) and 2(b) are illustrative diagrams for describing cleavage of graphene powder in this example. The raw material 3 containing graphite input from the fifth input unit 10e may be made to collide with the gas jet flows 9a to 9d input from the first to fourth input units 10a to 10d, and thereby the gas jet flows 9a to 9d intervene between the layers of graphite to cleave graphite. Furthermore, graphite in the raw material 3 may be made to collide with each other along with the gas jet flows to make a layer of graphite intervene between other layers of graphite to cleave graphite. Moreover, graphite in the raw material 3 may be made to collide with the inner wall of the process chamber 5 along with the gas jet flows, thereby cleaving graphite. The gas jet flows form streams in the process chamber 5, and thus the raw material 3 and the gas jet flows are made to collide with each other repeatedly multiple times. Graphene is easily broken in parallel to the plane of the regular octahedron due to the nature thereof liable to be cleaved, and the velocity of the gas jet flows 9a to 9d is desirably in a range of from 100 to 1,000 m/s. The range of velocity has been found by the present inventors as a result of repeated experimentations, and it has been found that cleavage of graphite may occur with a jet flow having a velocity in a range of from 100 to 1,000 m/s. When the velocity is less than 100 m/s, the cleavage may not occur sufficiently due to the insufficient strength of the jet flow, and when the velocity exceeds 1,000 m/s, the graphene may be difficult to be controlled to fine particles having a suitable size, and pores may occur in the crystals of graphene, from which it may be difficult to maintain the high quality of graphene. The jet flow may be input to the process chamber 5 along with graphite at a velocity in a range of from 100 to 1,000 m/s, and thereby the cleavage process may be performed to provide the graphene powder in the form of fine particles through cleavage of graphite.

The cleavage process is thus performed for a prescribed period of time, the cleavage process is completed after the lapse of a prescribed period of time, the dust collector 6a shown in FIG. 1 is turned on, the graphene powder 7 in the form of fine particles through cleavage is output from the output part 11, and the graphene powder 7 is separated and collected with the dust collector 6a. In the dust collector 6a, particles having a larger particle size than the graphene powder 7 in the form of flakes that have a prescribed particle size may be removed. The graphene powder 7 thus produced is retained in the output tank 6b and output therefrom on necessity. The graphene powder 7 output from the output tank 6b may be again placed in the raw material tank 2 through the pipe 19 depending on the cleavage condition, and the cleavage process may be repeated by inputting the graphene powder 7 into the process chamber 5. Thus, a loop may be formed by placing the graphene powder in the raw material tank 2 through the pipe 19, and thereby the cleavage process of the graphene powder 7 may be performed repeatedly multiple times. According to the procedures, the production of the graphene powder 7 is completed. In the case where particles having a larger particle size than the particles that have a prescribed particle size are removed in the dust collector 6a, only the particles having the larger size may be again subjected to the cleavage process through the loop.

According to the production method having the procedures described above, graphite may be cleaved to provide graphene powder 7 in the form of fine particles through cleavage. In the production apparatus 1 of graphene powder, the raw material 3 and the jet flow are input from different input units, but such a procedure may be employed that the raw material 3 is input to the compressor 4 and mixed with air or a gas, and a gas jet flow having the raw material 3 mixed therein is input from one or plural input units.

Another example of a production apparatus of graphene powder that utilizes a gas as a jet flow will be described with reference to FIG. 3. FIG. 3 is a second block diagram showing an apparatus for producing graphene powder in the examples. FIG. 3 shows a production apparatus 20 of graphene powder, in which a post-treatment after the cleavage is added to the structure of the production apparatus 1 of graphene powder shown in FIG. 1. The production apparatus 20 of graphene powder shows a case where the quality of graphene is modified with atmospheric pressure plasma. In FIG. 3, the same symbols as in FIG. 1 show the same components as in FIG. 1. The common components are the same as described above. The post-treatment added will be described herein.

In FIG. 3, the production apparatus 20 of graphene powder has, in addition to the structure of the production apparatus 1 of graphene powder shown in FIG. 1, a plasma treatment part 15, a high voltage power supply 16, and a gas cylinder 13. By applying a high voltage with the high voltage power supply 16, plasma may be generated in the plasma treatment part 15. In the plasma treatment part 15, atmospheric pressure plasma may be generated, or vacuum plasma may be generated. The gas cylinder 13 outputs an atmospheric gas, such as Ar, N₂, H₂, NH₃ or O₂.

In the plasma treatment part 15, plasma is radiated on the graphene powder 7 output from the output part 11 of the process chamber 5 to activate graphene. Simultaneously with the procedure, the gas output from the gas cylinder 13 is injected thereon and formed into plasma in the plasma treatment part 15, and thereby functional groups are attached to the end surfaces of graphene, thereby providing graphene powder 21 having functional groups attached thereto. According to the procedure, the modification treatment may be performed to impart dispersibility, electroconductivity, thermal conductivity, insulating property, heat radiation property, and the like to the graphene powder, thereby enhancing the quality of the graphene powder. The graphene powder 21 having functional groups attached thereto having been post-treated in the plasma treatment part 15 is separated and collected in the dust collector 6a through the pipe 18, retained in the output tank 6b, and output on necessity.

As described above, functional groups may be attached by performing a plasma treatment. In this case, plasma may be radiated on the graphene powder 7 by using an atmospheric gas, such as Ar, N₂, NH₃ or O₂, thereby providing the graphene powder 21 having functional groups attached thereto.

According to the production apparatus 20 of graphene powder shown in FIG. 3, the graphene powder 7 after cleavage may be subjected to a post-treatment in the plasma treatment part 15 to produce the graphene powder 21 having functional groups attached thereto, and thereby the quality of the graphene powder may be further enhanced. Specifically, the quality thereof, such as dispersibility, electroconductivity, thermal conductivity, insulating property, heat radiation property, and the like, may be enhanced.

The post-treatment employed may be other modification treatments, such as an ultraviolet ray ozone treatment, instead of the plasma treatment.

A production apparatus of graphene powder that utilizes a liquid as a jet flow will be described with reference to FIG. 4.

FIG. 4 is a third block diagram showing an apparatus for producing graphene powder in the example.

In FIG. 4, a production apparatus 30 of graphene powder has at least an ultrahigh pressure pump 34 as a jet flow output unit and a process chamber 49 as a chamber having a closed space, and the process chamber 49 has an input part 39 that inputs a liquid jet flow of a raw material 33 containing graphite and a liquid output from the ultrahigh pressure pump 34, and an output part 41 that outputs graphene powder in the form of fine particles formed through cleavage of graphene with the liquid jet flow in the process chamber 49. The production apparatus 30 of graphene powder may have a raw material tank 32 that receives and retains graphite, a liquid and the like, and an output tank, which is not shown in the figure.

In the production apparatus 30 of graphene powder shown in FIG. 4, the raw material 33 used is a mixture of natural graphite or graphite powder and a liquid, such as water or an organic solvent. Natural graphite or graphite powder and a liquid, such as water or an organic solvent, are placed in the raw material tank 32 and then form a raw material 33 in the form of slurry. Specifically, graphite as a raw material is suspended in the liquid to form a raw material in the form of fluid. The raw material 33 in the form of slurry is input from the raw material tank 32 through a pipe 38 to the ultrahigh pressure pump 34. Examples of the liquid used include water and an organic solvent, such as an alcohol solvent (e.g., ethanol, isopropanol and isobutanol), a ketone solvent (e.g., methyl ethyl ketone, methyl isobutyl ketone and diethyl ketone) and an ether solvent (such as dibutyl ether, dioxane and dimethylsulfoxide). The use of water may provide pure graphene powder without modification, and the use of an organic solvent may provide graphene powder that has functional groups attached thereto to provide functionality.

The ultrahigh pressure pump 34 as a jet flow input unit is a device that increases the pressure of the liquid and continuously delivers the liquid by pressurizing, and a normal ultrahigh pressure pump having been ordinarily used may be utilized therefor. The ultrahigh pressure pump 34 pressurizes the liquid contained in the raw material 33 in the form of slurry and thereby delivers liquid jet flows as an ultrahigh speed jet stream in two directions of pipes 36 and 37. The discharge pressure of the jet flow from the ultrahigh pressure pump 34 may be set at approximately from 10 to 500 MPa, and the jet flow nozzle diameter may be set at approximately from 0.1 to 1 mm. According to the configuration, the liquid jet flow may be output at a velocity in a range of approximately from 100 to 1,000 m/s. In the production apparatus 30 of graphene powder shown in FIG. 4, the raw material 33 in the form of slurry containing graphite and a liquid is placed in the ultrahigh pressure pump 34, and the raw material 33 in the form of slurry is output as a liquid jet flow from the ultrahigh pressure pump 34.

The process chamber 49 is a device that is shielded from the air with a valve, which is not shown in the figure, and maintains the inner atmosphere to high vacuum, and a normal rectangular process chamber having been ordinarily used may be utilized therefor. The process chamber 49 in this example is filled with a liquid. The input part 39 of the process chamber 49 inputs the liquid jet flows 42 and 43 as an ultrahigh speed jet stream of the raw material 33 in the form of slurry in two directions through the pipes 36 and 37, and has a first input unit 39a and a second input unit 39b. The first input unit 39a and the second input unit 39b each are constituted by a nozzle. This example shows a case where two input parts 39 are provided, in which the input directions of the first input unit 39a and the second input unit 39b are made to be opposite to each other. In this case, the first input unit 39a and the second input unit 39b are provided on the surfaces of the rectangular process chamber 49 that face each other, respectively. Plural pairs each constituted by the first input unit 39a and the second input unit 39b may be provided. The input part 39 may have a control unit, which is not shown in the figure, that controls the input directions of the first input unit 39a and the second input unit 39b to the process chamber 49. The control unit may control each of the input directions of the liquid jet flows 42 and 43 input from the first input unit 39a and the second input unit 39b to the process chamber 49. The control unit may be configured to make the input directions of two input units be opposite to each other, or may be configured to make the input directions directed to a particular position of the wall of the process chamber 49. In the process chamber 49, the liquid jet flows 42 and 43 of the raw material 33 may be made to collide with each other to cleave graphite directly. In alternative, the liquid jet flow containing the raw material 33 may be made to collide with the inner wall of the process chamber 49 to cleave graphite. The process chamber 49 outputs the graphene powder 40 in the form of fine particles through cleavage of graphite and the liquid from the output part 41. The graphene powder 40 output from the output part 41 may be again placed in the raw material tank 32 through a pipe 44 depending on the cleavage condition, and the cleavage process may be repeated.

In the case where an output tank, which is not shown in the figure, is provided, the output tank retains and outputs the graphene powder 40 and the liquid thus output from the output part 41 of the process chamber 49. After the cleavage, furthermore, the graphene powder 40 and the liquid output from the output part 41 may be subjected to a drying process for removing the liquid, thereby isolating the graphene powder 40 only. In the case where the liquid is an intended organic solvent, the graphene powder 40 contained in the organic solvent may be used as it is without a drying process performed. The liquid mixed in the raw material tank 32 and the liquid filled in the process chamber 49 may be the same as or different from each other.

An example of the production method of graphene powder in the example will be described with reference to FIG. 4. The process chamber 49 is filled with a liquid, such as water, and the process chamber 49 is turned on. The ultrahigh pressure pump 34 is turned on. Graphite powder as the raw material 33 and water are placed in the raw material tank 32, and the raw material 33 in the form of slurry is input in the ultrahigh pressure pump 34 through a pipe 38. The ultrahigh pressure pump 34 pressurizes the raw material 33 in the form of slurry, and outputs liquid jet flows as ultrahigh speed jet stream to pipes 36 and 37 at a velocity of 300 m/s, and the liquid jet flows 42 and 43 are input from the first input unit 39a and the second input unit 39b of the process chamber 49. In the process chamber 49, the first input unit 39a and the second input unit 39b are disposed to face each other, and the raw material 33 in the form of slurry is made to collide with each other as the liquid jet flows 42 and 43, thereby performing the cleavage process for cleaving graphite. In the process chamber 49, the input directions to the process chamber 49 in the first input unit 39a and the second input unit 39b are controlled by a control unit to make the liquid jet flow 42 and the liquid jet flow 43 collide with each other, or in alternative, the liquid jet flow 42 and the liquid jet flow 43 may be controlled to make them collide with the inner wall of the process chamber 49, respectively.

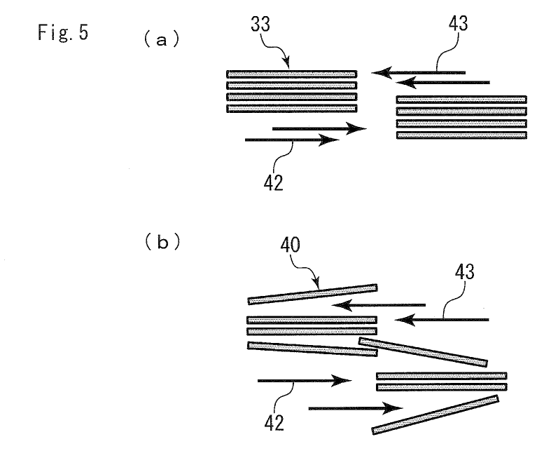

The cleavage process will be described with reference to FIGS. 5(a) and 5(b). FIGS. 5(a) and 5(b) are illustrative diagrams for describing cleavage of graphene powder in the example shown in FIG. 4. The raw material 33 in the form of slurry may be input to the process chamber 49 filled with water in the two directions of the first input unit 39a and the second input unit 39b, and collide with each other as the liquid jet flows 42 and 43, and thereby the liquid jet flows 42 and 43 of the raw material 33 in the form of slurry intervene between the layers of graphite to cleave graphite. Furthermore, graphite in the raw material 33 in the form of slurry may be made to collide with each other along with the liquid jet flows to make a layer of graphite intervene between other layers of graphite to cleave graphite. Moreover, graphite in the raw material 33 in the form of slurry may be made to collide with the inner wall of the process chamber 49 along with the gas jet flows, thereby cleaving graphite. Graphene is easily broken in parallel to the plane due to the nature thereof liable to be cleaved, and the velocity of the liquid jet flows 42 and 43 is desirably in a range of from 100 to 1,000 m/s, as similar to the case of a gas described above. When the velocity is less than 100 m/s, the cleavage may not occur sufficiently due to the insufficient strength of the jet flow, and when the velocity exceeds 1,000 m/s, the graphene may be difficult to be controlled to fine particles having a suitable size, and pores may occur in the crystals of graphene, from which it may be difficult to maintain the high quality of graphene. The jet flow may be input to the process chamber 49 along with graphite at a velocity in a range of from 100 to 1,000 m/s, and thereby the cleavage process may be performed to provide the graphene powder in the form of fine particles through cleavage of graphite.

The cleavage process is thus performed for a prescribed period of time, the cleavage process is completed after the lapse of a prescribed period of time, and the graphene powder 40 thus produced is output along with water from the output part 41. The graphene powder 40 and water thus output may be again placed in the raw material tank 32 through a pipe 44 depending on the cleavage condition, and the graphene powder 40 and water may be input to the process chamber 49 to repeat the cleavage process. Thus, a loop may be formed by placing the graphene powder in the raw material tank 32 through the pipe 44, and thereby the cleavage process of the graphene powder 40 may be performed repeatedly multiple times. According to the procedures, the production of the graphene powder 40 is completed. In this case, the graphene powder 40 is output along with water from the output part 41, and thus may be further subjected to a drying process. In the drying process, water may be removed by evaporation to isolate the graphene powder 40 only.

According to the production method having the procedures described above, graphite may be cleaved to provide graphene powder 40 in the form of fine particles through cleavage of graphite.

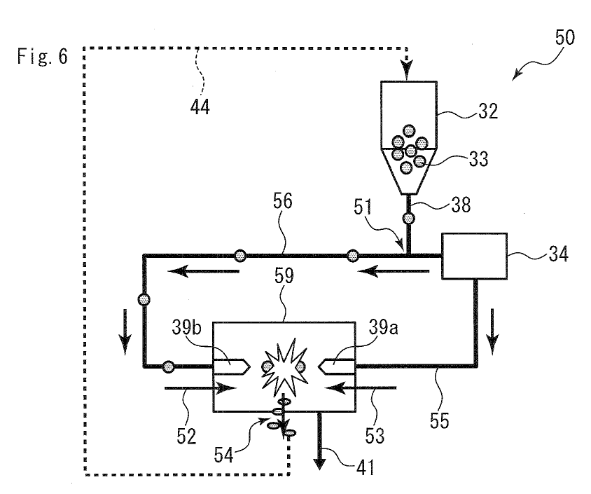

Another example of a production apparatus of graphene powder that utilizes a liquid as a jet flow will be described with reference to FIG. 6.

FIG. 6 is a fourth block diagram showing an apparatus for producing graphene powder in the example. FIG. 6 shows a case using a liquid as similar to the production apparatus 30 of graphene powder shown in FIG. 4, in which the same symbols as in FIG. 4 show the same components as in FIG. 4. The common components are the same as described above. In the production apparatus 30 of graphene powder shown in FIG. 4, the raw material 33 in the form of slurry is commonly input in the two directions to the process chamber 49, whereas in the production apparatus 50 of graphene powder shown in FIG. 6, for example, the raw material 33 in the form of slurry and a liquid jet flow containing only a liquid are input in two directions to the process chamber 49. Only the components that are different from the production apparatus 30 of graphene powder shown in FIG. 4 are described herein.

In the production apparatus 50 of graphene powder shown in FIG. 6, the raw material 33 in the form of slurry in the raw material tank 32 is not input to the ultrahigh pressure pump 34, and the ultrahigh pressure pump 34 pressurizes only a liquid to output liquid jet flows in the two directions of the pipes 55 and 56. The liquid jet flow containing only the liquid output from the ultrahigh pressure pump 34 is input from the first input unit 39a of the process chamber 49 through the pipe 55. The raw material 33 in the form of slurry in the raw material tank 32 is mixed with the liquid jet flow from the ultrahigh pressure pump 34 at a confluence point 51 on the pipe 38, and input from the second input unit 39b of the process chamber 49. In the process chamber 49, the liquid jet flow 52 containing the raw material 33 in the form of slurry and the liquid jet flow 53 containing only the liquid are made to collide with each other to perform the cleavage process of cleaving graphite.

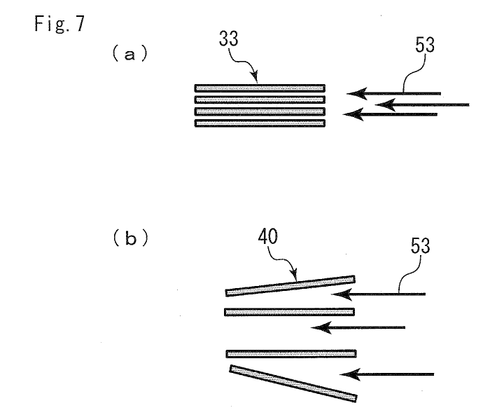

The cleavage process will be described with reference to FIGS. 7(a) and 7(b). FIGS. 7(a) and 7(b) are illustrative diagrams for describing cleavage of graphene powder in the example shown in FIG. 6. The raw material 33 in the form of slurry may be input from the second input unit 39b to the process chamber 49 filled with a liquid, whereas the liquid jet flow containing only the liquid is input from the first input unit 39a thereto, thereby making the raw material 33 in the form of slurry and the liquid jet flow 53 collide with each other, and thus the liquid jet flow 53 intervenes between the layers of graphite to cleave graphite. The velocity of the liquid jet flows 52 and 53 may be the same as in the aforementioned examples. According to the procedures, the cleavage process may be performed, and the graphene powder 54 in the form of fine particles through cleavage of graphite may be obtained. In this case, such processes may be performed that the graphene powder after cleavage is subjected to a drying process and is placed again in the raw material tank 32 to form a loop, as similar to the production apparatus 30 of graphene powder shown in FIG. 4.

According to the production method having the procedures described above, graphite may be cleaved to provide graphene powder 54 in the form of fine particles through cleavage of graphite. In the production apparatus 50 of graphene powder shown in FIG. 6, the raw material 33 in the form of slurry input from the second input unit 39b of the process chamber 49 is configured to be mixed with the liquid jet flow from the ultrahigh pressure pump 34, but only the raw material 33 in the form of slurry may be input from the second input unit 39b without mixing with a liquid jet flow. In this case, graphite in the raw material 33 in the form of slurry input from the second input unit 39b is cleaved with the liquid jet flow input from the first input unit 39a as another input unit, thereby producing the graphene powder 54 in the form of fine particles.

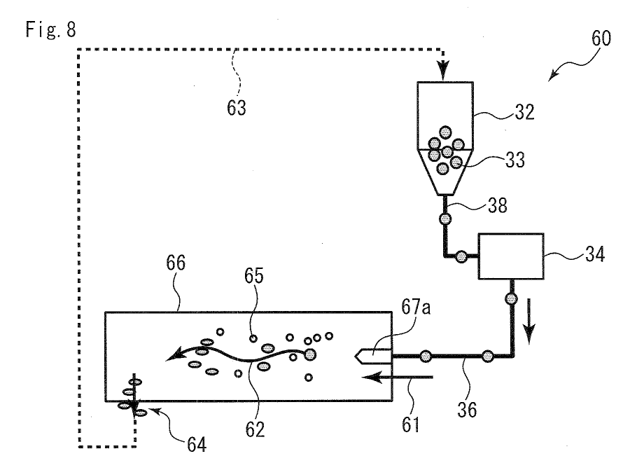

Another example of a production apparatus of graphene powder that utilizes a liquid as a jet flow will be described with reference to FIG. 8.

FIG. 8 is a fifth block diagram showing an apparatus for producing graphene powder in the example. FIG. 8 shows a case using a liquid as similar to the production apparatus 30 of graphene powder shown in FIG. 4, in which the same symbols as in FIG. 4 show the same components as in FIG. 4. The common components are the same as described above. In the production apparatus 30 of graphene powder shown in FIG. 4, the raw material 33 in the form of slurry is commonly input in the two directions to the process chamber 49, whereas in the production apparatus 50 of graphene powder shown in FIG. 6, for example, a liquid jet flow of the raw material 33 in the form of slurry is input in one direction to the process chamber 66. Only the components that are different from the production apparatus 30 of graphene powder shown in FIG. 4 are described herein.

In the production apparatus 60 of graphene powder shown in FIG. 8, the raw material 33 in the form of slurry in the raw material tank 32 is input to the ultrahigh pressure pump 34 and pressurized in the ultrahigh pressure pump 34, and thus is input as a liquid jet flow from the first input unit 67a of the process chamber 66 through the pipe 36. In the process chamber 66, the liquid jet flow 61 containing the raw material 33 in the form of slurry is input from the first input unit 67a to create a cavitation effect, with which the cleavage process of cleaving graphite is performed. The pressure difference is formed by making the liquid jet flow 61 inflow to the liquid, whereby bubbles 65 thus generated through the cavitation effect penetrate into the cleavage surfaces of graphite to clave graphite, and the extinguishment of the bubbles 65 cleaves graphite.

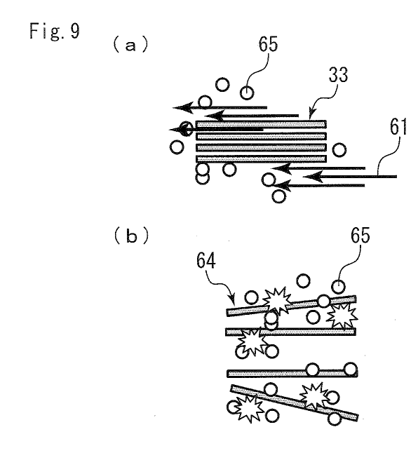

The cleavage process will be described with reference to FIGS. 9(a) and 9(b). FIGS. 9(a) and 9(b) are illustrative diagrams for describing cleavage of graphene powder in the example shown in FIG. 8. When the raw material 33 in the form of slurry, is input from the first input unit 67a to the process chamber 66 filled with a liquid, a cavitation effect may be created due to the pressure difference in the flow 62 of the liquid in the process chamber 66, and bubbles 65 are generated and extinguished in a short period of time. The bubbles 65 thus generated may penetrate into the cleavage surfaces of graphite to cleave graphite, and the extinguishment of the bubbles 65 may cleave graphite. The velocity of the liquid jet flow 61 maybe the same as in the aforementioned examples. According to the procedures, the cleavage process may be performed, and the graphene powder 64 in the form of fine particles through cleavage of graphite may be obtained. In this case, such processes may be performed that the graphene powder after cleavage is subjected to a drying process and is placed again in the raw material tank 32 to form a loop, as similar to the production apparatus 30 of graphene powder shown in FIG. 4.

According to the production method having the procedures described above, graphite may be cleaved to provide graphene powder 64 in the form of fine particles through cleavage of graphite. In the production apparatus 60 of graphene powder shown in FIG. 8, such a configuration may be employed that the process chamber 66 is not filled with a liquid but is filled with a gas or is made vacuum, to which the raw material 33 in the form of slurry is input from the first input unit 67a, and thereby the raw material 33 in the form of slurry is made to collide directly with the wall inside the process chamber 66 to cleave graphite. According to the procedure, graphene powder in the form of fine particles through cleavage may be produced.

The graphene powder of the invention may be produced by the five production apparatuses of graphene powder shown above. Furthermore, plural apparatuses from the five configurations above may be combined to perform a cleavage process containing two or more stages. For example, the graphene powder 40 that is produced through the cleavage process of the production apparatus 30 of graphene powder may be placed in the raw material tank 32 of the production apparatus 50 of graphene powder and subjected to the cleavage process of the production apparatus 50 of graphene powder, thereby performing a cleavage process containing two stages. In this case, the graphene powder may be transferred to another production apparatus of graphene powder instead of the process, in which the graphene powder thus formed is again placed in the raw material tank of the same production apparatus to form a loop for performing the cleavage process plural times, or in alternative, the cleavage process with another production apparatus of graphene powder may be added to the process of performing the cleavage process plural times by placing the graphene powder again in the raw material tank to form a loop.

In the examples, furthermore, a pretreatment for weakening the bonding force of graphene may be performed before placing the raw material in the production apparatus of graphene powder. Examples of the pretreatment include a depressurization treatment of decreasing the pressure of the atmosphere of the raw material containing graphite by depressurizing a vacuum furnace having the raw material containing graphite placed therein, a heating treatment of heating the raw material in a vacuum furnace having the raw material containing graphite placed therein, a solvent immersion treatment of immersing the raw material into an acidic or alkaline solvent having a low concentration, and a vibration treatment of applying an ultrasonic vibration to the raw material. These pretreatments may be appropriately combined. By subjecting the raw material containing graphite to the pretreatment for weakening the bonding force of graphene, graphite may be further liable to be cleaved. In the case where a liquid and a raw material are mixed to form a slurry, graphite powder formed by pulverizing graphite may be subjected to vibration with an ultrasonic wave or the like, thereby dissolving graphite in the liquid. According to the procedure, the graphite powder may be dispersed into the liquid further uniformly. By applying the vibration treatment by applying vibration with an ultrasonic wave or the like, a cavitation effect may be created, with which the raw material in a waiting state may be roughly cleaved, and thus the raw material may be further liable to be cleaved with the jet flow. The pretreatment may be performed in the production apparatuses of graphene powder, or may not be performed in the production apparatuses of graphene powder but may be performed in a separate apparatus. In the case where the pretreatment is performed in the production apparatuses of graphene powder, the material in a waiting state may be subjected to the pretreatment, thereby producing graphene more efficiently.

In the case where a vibration treatment of applying vibration with an ultrasonic wave or the like is performed as a pretreatment, the treatment may be performed by providing an ultrasonic vibrator 45 is added inside or outside the raw material tank 32 as shown in FIG. 4. In this case, the raw material 33 formed by mixing the liquid and graphite powder is placed in the raw material tank 32 and vibrated with the ultrasonic vibrator 45. According to the procedure, the liquid and the raw material 33 are mixed, and simultaneously a cavitation effect is created on graphite of the raw material 33, thereby cleaving graphite. The vibration treatment with an ultrasonic wave by the ultrasonic vibrator 45 may be performed not only at the time of placing the raw material, but also at the time of outputting the raw material 33 to the process chamber 49 through the pipe 38, and thereby the raw material in a waiting state for outputting may be roughly cleaved. According to the procedure, graphite may be further liable to be cleaved with the jet flow. In the other production apparatuses 50 and 60 of graphene powder, an ultrasonic vibrator 45 may be provided inside or outside the raw material tank 32, and thereby the vibration treatment with an ultrasonic wave by the ultrasonic vibrator 45 may be performed. In the case of the production apparatuses 1 and 20 of graphene powder, after mixing graphite in the liquid, to which the vibration treatment with an ultrasonic wave by the ultrasonic vibrator 45 may be applied, the dried graphene powder may be obtained through the drying process for drying the liquid, and by using the dried graphene powder, graphite may be roughly cleaved. Thus, the pretreatment performed may facilitate cleavage of graphite with the jet flow.

In the production apparatuses of graphene powder described above, one of an atmospheric pressure plasma treatment, an ultraviolet ray ozone treatment, and a vacuum plasma treatment may be performed as a post-treatment after the cleavage. The graphene powder may also be mixed with one of water, a solvent, a resin, and an ionic liquid, as a post-treatment after the cleavage.

On the shipment of the graphene powder 7 or 21 formed as described above, or the dried graphene powder 40, 54 or 64, the graphene powder may be in vacuum or filled with an inert gas, such as nitrogen or argon, thereby preventing graphene from being oxidized. A shipping bag for packaging the graphene powder preferably has a gas barrier property (i.e., a function of shielding water, oxygen and the like), a light shielding property (i.e., a function of shielding a visible ray, an ultraviolet ray and the like), and the like. In the case where the graphene powder is mixed with a liquid such as a solvent, the graphene powder may be shipped with the liquid untouched. Furthermore, the graphene powder may be mixed with a resin, rubber or the like to form pellets of a master batch, which may be shipped.

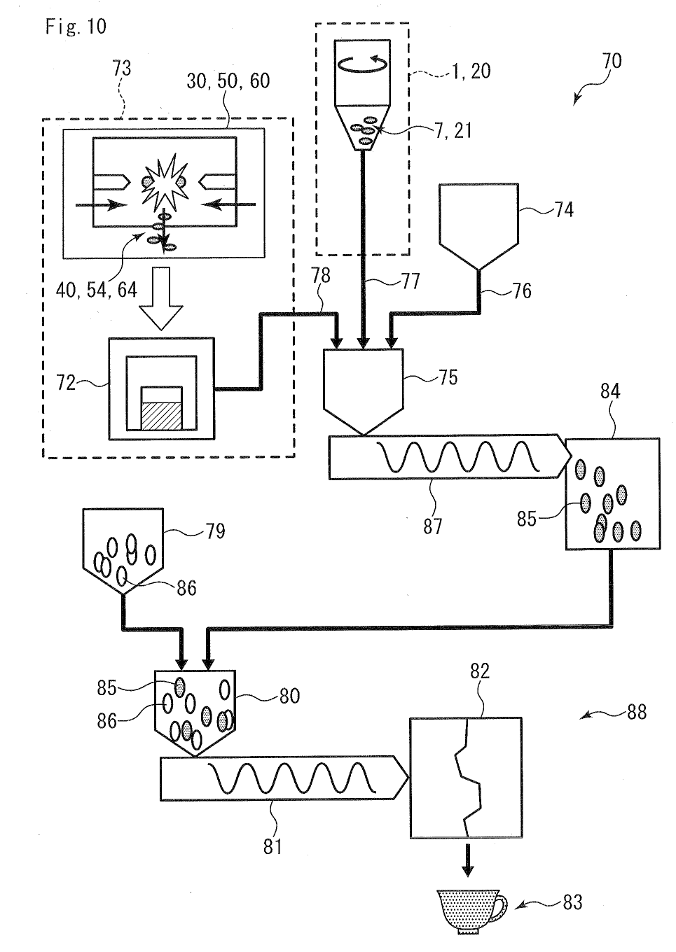

A production method and a production apparatus in the case where pellets of a master batch are produced, and a product obtained thereby will be described. A production method and a production apparatus in the case where the graphene powder is mixed with a resin, rubber or the like to form pellets of a master batch will be described with reference to FIG. 10. The master batch referred herein means a product in the form of pellets that has a dye, a pigment, a functional material or the like added in a high concentration to a resin base material. By forming into pellets, the graphene powder may be improved in handleability, for example, the pellets may be easily mixed uniformly in a material, may not contaminate equipments, may not fly, maybe easily stored, and may be easily weighed.

FIG. 10 is a first block diagram showing a production apparatus of mixing graphene powder with a resin, rubber or the like to form pellets of a master batch, and an apparatus for producing a resin product by using the master batch, in the example. The upper half of FIG. 10 shows a production apparatus 70 of pellets of mixing the graphene powder with a resin, rubber or the like to form pellets of a master batch, and the lower half of FIG. 10 shows a production apparatus 88 of a product for producing a resin product by using the master batch. The upper half of FIG. 10 shows the case where one of the graphene powder 7 or 21 that is produced with the production apparatus 1 or 20 of graphene powder utilizing a gas as the jet flow and the graphene powder 40, 54 or 64 that is produced with the production apparatus 30, 50 or 60 of graphene powder utilizing a liquid as the jet flow is used and mixed with a resin, rubber or the like to form pellets of a master batch. For convenience of explanation, FIG. 10 shows all the graphene powder 7 or 21 that is produced with the production apparatus 1 or 20 of graphene powder utilizing a gas as the jet flow and the graphene powder 40, 54 or 64 that is produced with the production apparatus 30, 50 or 60 of graphene powder utilizing a liquid as the jet flow, but at least one of the production apparatuses of graphene powder may be used, and the graphene powder produced thereby may be mixed with a resin, rubber or the like to form pellets of a master batch. Examples of the resin or rubber utilized include a thermoplastic resin, a thermosetting or UV-curable resin, and natural or synthetic rubber. Specific examples of the thermoplastic resin include ABS, PC (polycarbonate), PP (polypropylene), PE (polyethylene), PET (polyethylene terephthalate), PS (polystyrene), PA (nylon), PVC (polyvinyl chloride), polyvinylidene chloride, PMMA (acrylic resin), PTFE (Teflon (a registered trade name)), polyacetal, and a fluorine resin. Examples of the thermosetting or UV-curable resin include EP (epoxy resin), MF (melamine resin), PUR (polyurethane), and PI (polyimide). Examples of the natural or synthetic rubber include NBR (nitrile rubber), ACM (acrylic rubber), U (urethane rubber), and Q (silicone rubber).

In the production apparatus 70 of pellets shown in the upper half of FIG. 10, any injection molding machine having been used for adding an additive to a resin, rubber or the like and forming pellets of a master batch according to the injection molding may be used. The production apparatus 70 of pellets has a raw material hopper 74, in which a resin or rubber as a raw material is placed, a mixing hopper 75 that mixes the raw material and the graphene powder therein, an injection molding part 87 that injection-molding the raw material and the graphene powder having been mixed, into pellets, and a storing part 84 that stores the pellets thus molded. In the raw material hopper 74, a raw material, such as a resin or rubber, is placed. In the mixing hopper 75, the graphene powder 7 or 21 that is produced with the production apparatus 1 or 20 of graphene powder utilizing a gas as the jet flow and the raw material in the raw material hopper 74 are placed and mixed to form a material having the graphene powder added thereto. In the injection molding part 87, the material having the graphene powder added thereto is melted by heating, injected and molded in a die of a pellet with screws, which are not shown in the figure, and output to the storing part 84. The storing part 84 stores a master batch 85 produced from the resin having the graphene powder added thereto.

The master batch 85 may be produced by utilizing the graphene powder in the example as described above, whereby graphene may be easily dispersed in a resin or rubber, and the mixing ratio by weight of the graphene powder therein with respect to the raw material such as a resin or rubber may be 50% or more.

In the case where the graphene powder 40, 54 or 64 that is produced with the production apparatus 30, 50 or 60 of graphene powder utilizing a liquid as the jet flow is used, the graphene powder 40, 54 or 64 contained in the liquid is dried in a drying part 72 for removing the liquid to provide the graphene powder containing no liquid, which is then placed in the mixing hopper 75 of the production apparatus 70 of pellets, and subsequently the pellets having the graphene powder added thereto may be produced according to the aforementioned injection molding method.

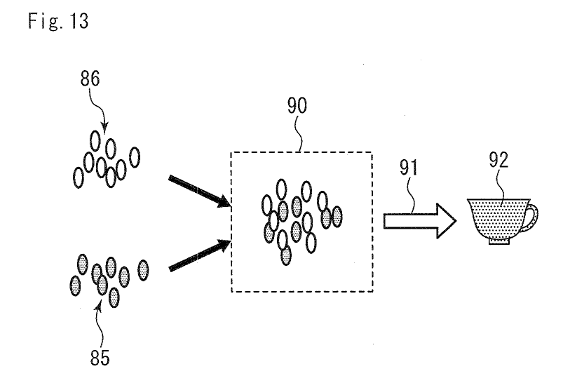

Furthermore, various resin products or rubber products may be produced by utilizing the master batch 85 thus produced. FIG. 13 is an illustrative diagram showing a process of producing a product with the master batch having the graphene powder added thereto in the example. As described above, the master batch 85 is produced by utilizing the graphene powder in the example with the production apparatus 70 of pellets, and a raw material 86, such as a resin or rubber, for various products and the master batch 85 may be mixed and molded (molding process 90) to provide a colored molded product 92.

A production apparatus of a product by the molding process 90 is shown in the lower half of FIG. 10. The lower half of FIG. 10 shows the production apparatus 88 of a product for producing a resin or rubber product by mixing the raw material 86 of various product with the master batch 85. The production apparatus 88 of a product used may be an injection molding machine having been used for producing a product by injection molding a resin, rubber or the like. The production apparatus 88 of a product has a raw material hopper 79, in which a resin or rubber as the raw material 86 is placed, a mixing hopper 80 that mixes the raw material 86 and the master batch 85 therein, an injection molding part 81 that is melted and injected the raw material and the master batch 85 having been mixed, and a die 82 for various products. The raw material 86, such as a resin or rubber, for various products is placed in the raw material hopper 79. In the mixing hopper 80, the raw material 86 and the master batch 85 are placed and mixed to form a material having the graphene powder added thereto. In the injection molding part 81, the material having the graphene powder added thereto is melted by heating, injected and molded in a die of a product with screws, which are not shown in the figure. Aftermolding, the product 83 is completed by taking out therefrom. Examples of the resin or rubber used as the raw material of various products include a thermoplastic resin, a thermosetting or UV-curable resin, and natural or synthetic rubber. Specific examples of the thermoplastic resin include ABS, PC (polycarbonate), PP (polypropylene), PE (polyethylene), PET (polyethylene terephthalate), PS (polystyrene), PA (nylon), PVC (polyvinyl chloride), polyvinylidene chloride, PMMA (acrylic resin), PTFE (Teflon (a registered trade name)), polyacetal, and a fluorine resin. Examples of the thermosetting or UV-curable resin include EP (epoxy resin), MF (melamine resin), PUR (polyurethane), and PI (polyimide). Examples of the natural or synthetic rubber include NBR (nitrile rubber), ACM (acrylic rubber), U (urethane rubber), and Q (silicone rubber). Examples of the various products applied include a wide variety of products, such as a plastic product and a rubber product, and the graphene powder may be added to the various products.

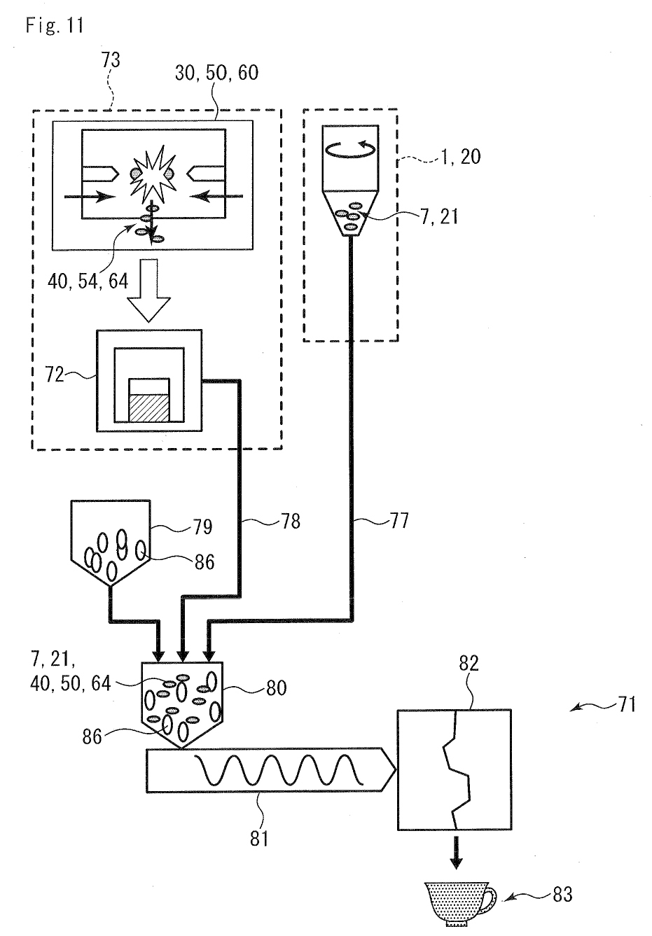

As shown in FIG. 11, furthermore, various products may be produced by mixing the graphene powder 7, 21, 40, 54 or 64 in the examples directly with the raw material 86 of various product. In FIG. 11, the same symbols as in FIG. 10 show the same components as in FIG. 10, and FIG. 11 shows a process of producing a product by injection molding that is performed similarly as in FIG. 10.

As described above, the graphene powder of the examples may be added to a resin or rubber on producing a resin or rubber product, and thereby the tensile strength of the product may be enhanced, electroconductivity may be imparted to the product, thermal conductivity may be imparted to the product, and a gas is difficult to pass through the product, thereby imparting higher gas barrier property than the simple material to the product. The tensile strength may be enhanced by utilizing the graphene powder of the examples due to such a mechanism that plural flakes of the graphene powder overlap each other to form wrinkles on the surface, and the wrinkles and the resin have enhanced bonding property, which prevents the interfacial slip of the composite material and increases the density. While most of resins have insulating property, the addition of the graphene powder of the examples to the resins may impart electroconductivity thereto due to the electroconductivity of the graphene powder, and thus the resins may have electroconductivity. The electroconductivity thus imparted may also provide effects of antistatic property, electromagnetic shielding, and the like. As for the thermal conductivity, the addition of the graphene powder of the examples may impart thermal conductivity, as similar to the electroconductivity. Accordingly, heat radiation property may be imparted to a material, which thus may be utilized in various products, for example, in all the components, such as a chassis, of an information processing device and the like. Furthermore, the graphene powder of the examples may be dispersed in a resin, and thus a gas is difficult to pass through the resin, thereby imparting higher gas barrier property than the simple material to the resin. Bags for foods, medical drugs and the like have currently a complex multilayer structure, but the graphene powder of the examples may be utilized by simply mixing into the resin, and thus the production process thereof may be simplified. The graphene powder of the examples may achieve a large dispersed amount, and the use of the graphene powder of the examples may facilitate dispersion of graphene in a resin or rubber and may also provide the effect thereof even in a mixing ratio by weight of the graphene powder therein with respect to the raw material such as a resin or rubber of 10% or less. The use of a resin having the graphene powder of the examples added thereto may provide a resin product that is excellent in electroconductivity, thermal conductivity, transparency, corrosion resistance, and gas barrier property.

The molding method of the product may be any production method other than the injection molding described above. Examples of the production method include blow molding, vacuum molding, foam molding, and polymerization molding (such as heating, UV (ultraviolet ray) and EB (electron beam)). The graphene powder may be mixed and added to a raw material on molding by these molding methods, and thereby a product having the graphene powder applied thereto may be molded. The graphene powder may be applied not only to products using a resin or rubber as a raw material, but also to molded products of various powder systems, such as a ceramic material before sintering (e.g., a green sheet), an iron material (e.g., ferrite), a carbon material and a ceramic material, low melting point glass, and the like.

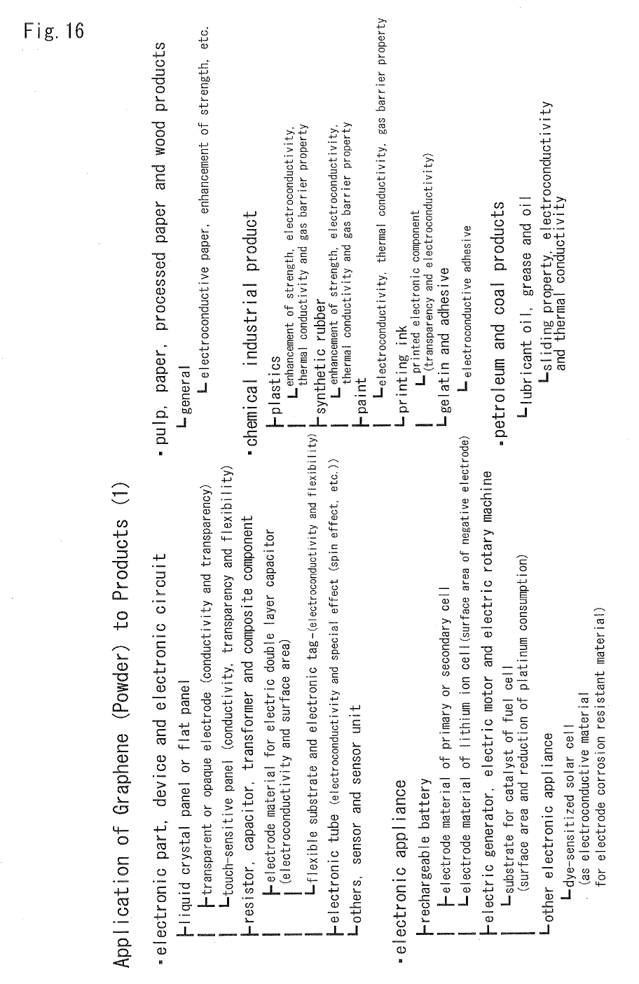

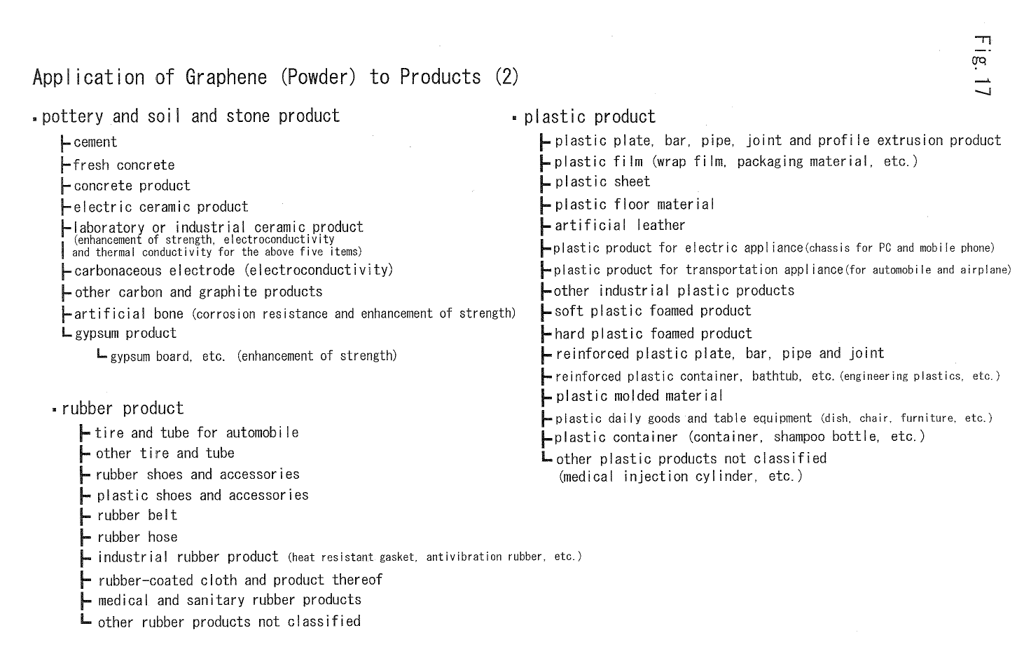

The graphene powder of the examples not only may be added to a resin or rubber product, but also may be mixed and added on producing various other products and may be added to a product after producing. By utilizing the graphene powder of the examples, graphene that has high purity and good quality in the form of fine particles and achieves a large dispersed amount may be utilized in products and components of various industrial products, electronic devices, and the like. The graphene powder may be mixed in any type of products due to the excellent electroconductivity, thermal conductivity, transparency, electrode corrosion resistance and flexibility thereof, and the graphene powder may be dispersed uniformly due to the good dispersibility thereof. The graphene powder may be applied, for example, to the products shown in FIGS. 16 and 17.

FIGS. 16 and 17 are illustrative diagrams showing various products having the graphene powder of the examples applied thereto and effects thereof. As shown in FIGS. 16 and 17, the graphene powder may be applied to any type of products including an electronic part, device or electronic circuit, an electronic appliance, a household electric component, an automobile component, a machine component, an electric component, a pottery or soil and stone product, a pulp, paper, processed paper or wood product, a chemical industrial product, a petroleum or coal product, a plastic product, and a rubber product.

As the electronic part, device or electronic circuit, and the electronic appliance, for example, the graphene powder may be dispersed in a solvent and may be applied to a liquid crystal or flat panel, a transparent or opaque electrode, a touch-sensitive panel, a resistor, capacitor, transformer or composite component, an electrode material for an electric double layer capacitor, a rechargeable battery, an electrode material for a primary or secondary cell, an electrode material for a lithium ion cell, an electric generator, electric motor or electric rotary machine, a substrate for a catalyst of a fuel cell, an electric machinery component, a dye-sensitized solar cell, a flexible substrate, and an electronic tag, sensor or sensor unit. The use of the graphene powder may provide a product excellent in electroconductivity, thermal conductivity, transparency, electrode corrosion resistance, and the like. Furthermore, the graphene powder having electroconductivity may be dispersed uniformly, thereby reducing the surface area of the product, and the graphene powder may be added to a flexible product due to the flexibility of the graphene powder.

The graphene powder of the examples may be added to raw materials of products and thus may be applied to a pottery or soil and stone product, a pulp, paper, processed paper or wood product, a chemical industrial product, a petroleum or coal product, a plastic product, and a rubber product, such as cement, fresh concrete, a concrete product, an electric ceramic product, a laboratory or industrial ceramic product, a carbonaceous electrode, a carbon or graphite product, an artificial bone, a gypsum product, a gypsum board, plastics, synthetic rubber, a paint, a printing ink, a printed electronic component, gelatin or an adhesive, an oil, a lubricant oil or grease, a pipe, a building material, a food wrap film, a medical wrap film, a kitchen product, a toy, a chassis for an information processing device, a household electric equipment, a beverage PET bottle, a machinery component, an industrial adhesive, a heat radiation grease, a packaging material, engineering plastics, furniture, a tire, medical rubber, a heat resistant gasket, antivibration rubber, and a rubber product. The use of the graphene powder may provide a product excellent in electroconductivity, thermal conductivity, transparency, corrosion resistance and gas barrier property.

The graphene powder of the examples may be dispersed in a liquid at the PZC (point of zero charge). For example, the graphene powder may be dispersed in an ink at the PZC, thereby providing an ink containing the graphene powder (i.e., a graphene ink). Furthermore, the graphene powder may be dispersed in a solution or a resin dispersion at the PZC, thereby providing a solution containing the graphene powder (i.e., a graphene solution) or a resin dispersion containing the graphene powder (i.e., a graphene resin dispersion), as a product using the graphene powder.

The PZC is a phenomenon that is referred to as a Z (zeta) potential or an isoelectric point, and means that a substance is dispersed in a liquid by balancing the potentials of the substances dispersed in the liquid. For example, the graphene powder may be dispersed in a liquid by balancing the potential through control of the pH in the liquid. The graphene ink, graphene solution and graphene resin dispersion thus produced may be handled in the same manner as ordinary ink, solution and resin dispersion, with which various products may be further produced. The graphene ink, graphene solution and graphene resin dispersion thus produced may be ink, solution and resin dispersion that have electroconductivity due to graphene added thereto.

According to the examples described above, graphene powder that may be mass-produced with high quality, an apparatus for producing graphene powder, a method for producing graphene powder, and a product using the graphene powder may be provided. The graphene powder produced by the production apparatus is formed only by cleaving the raw material containing graphite with the jet flow, and thus may suffer no contamination due to the absence of contamination with other substances, and thus graphene having high purity and good quality in the form of fine particles may be obtained. The graphene powder has a flake shape with having cleavage surfaces like leaves due to the two-dimensional cleavage. By the formation of fine particles, the graphene powder is constituted by graphite that is formed into flakes having a suitable particle size. By the formation of flakes, a large surface area is obtained to increase the contact area to other substances, thereby enhancing the conductivity and the dispersibility. In particular, the graphene powder may be formed to have a flake shape, and thereby the dispersibility thereof is enhanced to achieve a large dispersed amount.

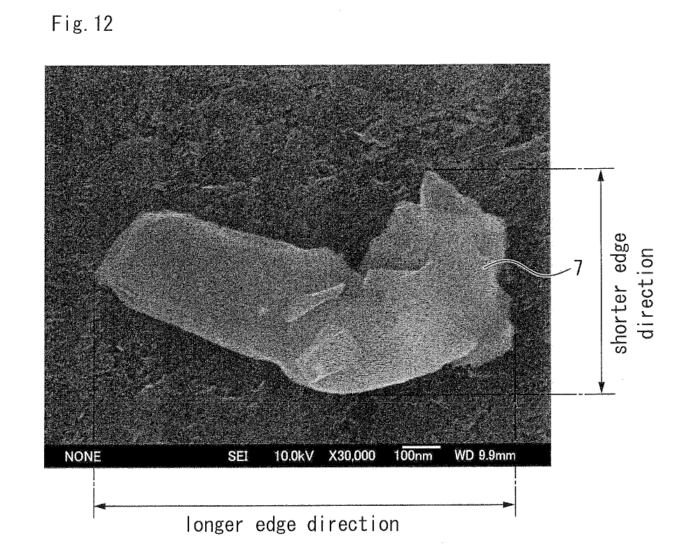

The graphene powder 40 that is produced by the production method and the production apparatus of graphene powder in the example shown in FIG. 4 will be described with reference to FIG. 12. FIG. 12 is an image obtained by observing the graphene powder 40 that is produced by the production apparatus of graphene powder in the example shown in FIG. 4 with a scanning electron microscope (SEM). As shown in FIG. 12, the graphene powder 40 has a cleavage surface on the upper surface thereof, and in this example, the length (width) of the cleavage surface in the direction of the longer edge was approximately 990 nm. The length of the cleavage surface in the direction of the longer edge herein means a width size of the longest part on observing the cleavage surface from the above. The thickness of the graphene powder 40 (in the direction perpendicular to the cleavage surface) was approximately 19.5 nm at the smallest (thinnest) part, and was approximately 200 nm at the largest (thickest) part. The observation of the other graphene powder 40 revealed that the length of the longer edge of the cleavage surface was approximately 50 to 3,000 times the smallest thickness of the graphene powder 40, and the graphene powder was constituted by 70% or more of such graphene powder. As the layers of graphene, a graphene single layer to approximately 300 layers were observed. The observation of the graphene powder produced by the other production apparatus of the examples revealed that the length of the longer edge of the cleavage surface was from 30 to 10,000 times the smallest thickness of the graphene powder, and the graphene powder was constituted by 70% or more of such graphene powder. As the layers of graphene, a graphene single layer to approximately 300 layers were observed.

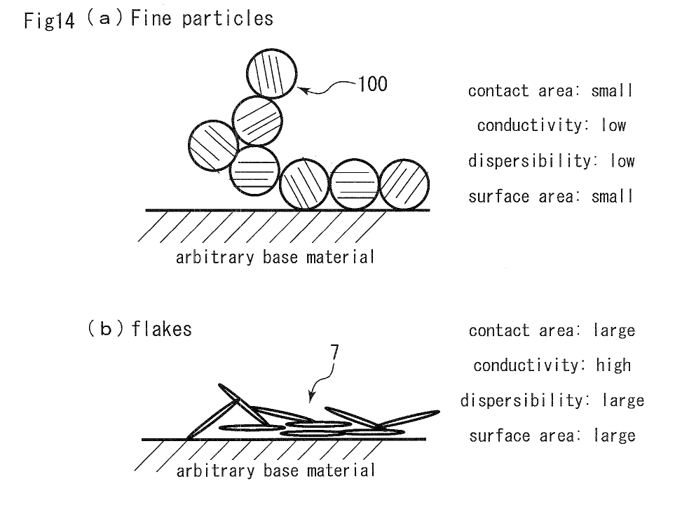

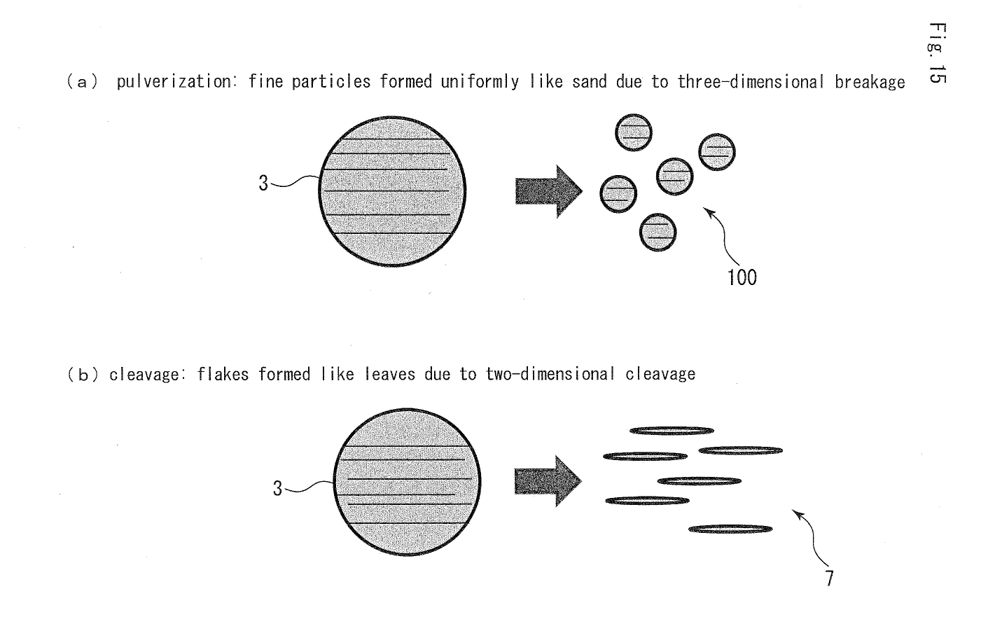

For describing the effect of the production method and the production apparatus of graphene powder in the examples described above, the fact that the cleavage of graphite in the invention is different from formation of fine particles of graphite through pulverization will be described with reference to FIGS. 14 and 15. FIG. 14 shows (a) a schematic diagram of fine particles through pulverization, and (b) a schematic diagram of graphene powder in the examples, and FIG. 15 shows (a) a schematic diagram of fine particles through pulverization and an illustrative diagram showing a state of pulverization thereof, and (b) a schematic diagram of graphene powder in the examples and an illustrative diagram showing a state of cleavage thereof.

The graphene 100 formed into fine particles through pulverization is formed by three-dimensional pulverization of graphite, and thus formed into fine particles like sand with a large thickness, as shown in FIG. 15(a). Accordingly, when the graphene 100 formed into fine particles through pulverization is added to an arbitrary base material or the like as shown in FIG. 14(a), the contact area to the other substances is small, the conductivity is small, the dispersibility is low, and the surface area is small. In the graphene powder 7 of the examples, on the other hand, as shown in FIG. 15(b), graphite crystals are broken by cleavage in parallel to the plane of the regular octahedron through the cleavage process, i.e., two-dimensional cleavage, to form the graphene powder 7 having a flake shape having cleavage surfaces like leaves. Accordingly, as shown in FIG. 14(b), when the graphene powder 7 through cleavage is added to an arbitrary base material or the like, the contact area to the other substances is large, the conductivity is large, and dispersibility is high, and the surface area is large, as compared to the material formed through pulverization.

The difference between the ordinary production method of graphene and the production method of the examples will be described. As described in the chapter of the background art, examples of the known production method of graphene include a supercritical method, an ultrasonic stripping method, a redox method, a plasma stripping method, an ACCVD (alcohol catalytic chemical vapor deposition) method, a thermal CVD (chemical vapor deposition) method, a plasma CVD method and an epitaxial method. In all the methods, since a large amount of raw material may not be processed at a high speed, graphene is difficult to be mass-produced, and as for the quality, graphene having high crystallinity and high quality tends to be expensive.

According to the production method and the production apparatus of the examples, on the other hand, graphite is simply cleaved with a jet flow, and thus graphene having high crystallinity and high quality may be mass-produced at a high speed, as compared to the ordinary production methods. As a result of experimentations made by the inventors, a raw material maybe processed at least at a rate of from 1 to 10,000 kg/h by the production method. In the production method of the examples, furthermore, natural graphite may be used as the raw material, the atmosphere of the chamber may be normal temperature and normal pressure, both wet type graphene and dry type graphene may be produced, and graphene obtained has high crystallinity without contamination and is excellent in mass-productivity.

The examples of the invention have been described with reference to the drawings, but the specific constitutions of the invention are not limited to the examples, and modifications and additions that are in a range without deviation from the substance of the invention are encompassed by the invention.

The example of the production method and the production apparatus of graphene powder shown in FIG. 4 show the case where the first input unit 39a and the second input unit 39b are provided on the surfaces of the rectangular process chamber 49 that face each other, respectively. However, for example, such a configuration may be used that the first input unit 39a and the second input unit 39b are provided on the same surface of the rectangular process chamber 49, and the input directions thereof are directed to a particular position inside the process chamber 49. For example, such a configuration may be used that the input direction of the first input unit 39a is directed to an obliquely downward direction, whereas the input direction of the second input unit 39b is directed to an obliquely upward direction, thereby making the liquid jet flows 42 and 43 collide at the center part inside the process chamber 49.

### REFERENCE SIGNS LIST

1 production apparatus
2
3 raw material tank
4 raw material
5 compressor
6 process chamber 6a dust collector 6b output tank
7 graphene powder
8 pipe
9 pipe
9a gas jet flow
9b gas jet flow
9c gas jet flow
9d gas jet flow
10 input part
10a first input unit
10b second input unit
10c third input unit
10d fourth input unit
10e fifth input unit
11 output part
13 gas cylinder
15 plasma treatment part
16 high voltage power supply
18 pipe
19 pipe
20 production apparatus
21 graphene powder
30 production apparatus
32 raw material tank
33 raw material
34 ultrahigh pressure pump
36 pipe
37 pipe
38 pipe
39 input part
39a first input unit
39b second input unit
40 graphene powder
41 output part
42 liquid jet flow
43 liquid jet flow
44 pipe
45 ultrasonic vibrator
49 process chamber
50 production apparatus
51 confluence point
52 liquid jet flow
53 liquid jet flow
54 graphene powder
55 pipe
60 production apparatus
61 liquid jet flow
64 graphene powder
65 bubbles
66 process chamber
67a first input unit
70 production apparatus of pellets
72 drying part
74 raw material hopper
75 mixing hopper
79 raw material hopper
80 mixing hopper
81 injection molding part
82 die
83 product
84 storing part
85 master batch
86 raw material
87 injection molding part
88 production apparatus of product
90 molding process
92 molded product

1-49. (canceled)

50. A method for producing graphene powder, comprising a cleaving step of cleaving a raw material containing graphite with a gas jet flow having a velocity of from 100 to 1,000 m/s, thereby producing graphene powder of fine particles.

51. The method for producing graphene powder according to claim 50, wherein the gas jet flow that contains the graphite is made to inflow to a chamber, and the gas jet flow that contains the graphite is made to collide with the chamber.

52. The method for producing graphene powder according to claim 50, wherein the graphene powder is produced at a rate of processing the raw material of at least 1 kg/h.

53. The method for producing graphene powder according to claim 50, wherein the raw material containing graphite is subjected to at least one pretreatment of:
a depressurization treatment of decreasing a pressure of an atmosphere of the raw material containing graphite,
a heating treatment of heating the raw material,
a solvent immersion treatment of immersing the raw material into an acidic or alkaline solvent, and
a vibration treatment of applying an ultrasonic vibration to the raw material.

54. The method for producing graphene powder according to claim 50, wherein the graphene powder is subjected, after the cleavage, to one treatment of:
an atmospheric pressure plasma treatment,
an ultraviolet ray ozone treatment, and
a vacuum plasma treatment.

55. The method for producing graphene powder according to claim 51, wherein the method comprises a loop step of making the graphene powder output from the chamber be input again to the chamber.

56. Graphene powder that is produced by the method for producing graphene powder according to claim 50 and is constituted by 70% or more of graphene powder that has a length of a longer edge of the cleavage surface that is from 30 to 10,000 times a thickness of the graphene powder.

57. The graphene powder according to claim 56, wherein the graphene powder is constituted by 70% or more of graphene powder that has a length of a longer edge of the cleavage surface that is from 50 to 3,000 times a thickness of the graphene powder.
